(19) United States
(12) Patent Application Publication
(10) Pub. No.: US 2010/0241652 A1
(43) Pub. Date: Sep. 23, 2010

(54) SYSTEM AND METHOD FOR SYNCHRONIZING PASSWORD-PROTECTED INFORMATION ACROSS AN ARBITRARY SET OF NETWORKS

(76) Inventors: HUMERA FASIHUDDIN, Hadley, MA (US); Zachary HUBBARD, Easthampton, MA (US)

Correspondence Address: Saul Ewing LLP (Baltimore);Attn: Patent Docket Clerk, Penn National Insurance Plaza, 2 North Second Street, 7th Floor, Harrisburg, PA, 17101, US

(21) Appl. No.: 12/724,275

(22) Filed: Mar. 15, 2010

Related U.S. Application Data
(60) Provisional application No. 61/160,236, filed on Mar. 13, 2009.

(51) Int. Cl. G06F 17/30

(52) U.S. Cl. 707/769; 707/802; 707/E17.108; 707/E17.005

(57) ABSTRACT

Network information is stored for different services in different private databases. Users of a particular service may search, through documented APIs, web interfaces, or other means, that service's database for social network information, typically providing account credentials to authenticate themselves in order to gain search results. This invention enables users store their various network credentials in a third party service. Users of this third party service may submit queries to the service containing some identifying information about an individual, organization, or group; or identifying information about a product or service; or similarly stored private data. The third party service searches for identifying information that may be stored across that user's various networks through public and private APIs, by simulating a normal browser-based search, or by other means, typically assuming the identity of the searching user on each service. Prior to search, the third party service scans the user's computing device, indexes the results and uses the information to return results with the highest-degree of accuracy.

### TECHNICAL FIELD

The teachings herein generally relate to data processing, and, more particularly, but not exclusively to spanning multiple protected databases for retrieving or modifying information.

### BACKGROUND

Many entities maintain protected databases of social networks varying in size from several users to several million users. Each network enables a user to find an entity via a database and invite that entity to join the user's virtual social circle. However, as the use and number of social networks increases, it presents an ever-increasing challenge for users to manage their connections between multiple networks.

Social network information and contact information is stored for each service in a different private database. Users of a particular service search through that service's database to find social network matches, typically providing account credentials to authenticate themselves in order to gain search results. Further, a particular service search through that service's database may require the User to pass a human interactive proof, which establishes that the user is a human being and not a computer program. As users make new connections, or attempt to engage existing connections in the online world, users are required to remember not only the myriad of networks they belong to, but also must become familiar with each social network's particular service search. Also, if users wish to conduct multiple searches across multiple social networks, this is a time-consuming and difficult task due to the need that each search will require the user to input redundant information, follow different instructions between each network, and successfully pass any protection measures. It is with respect to these problems and others that improvements are desired.

### SUMMARY

Network information is stored for different services in different private databases. Users of a particular service may search, through documented APIs, web interfaces, or other means, that service's database for social network information, typically providing account credentials to authenticate themselves in order to gain search results. This invention enables users store their various network credentials in a third party service. Users of this third party service may submit queries to the service containing some identifying information about an individual, organization, or group; or identifying information about a product or service; or similarly stored private data. The third party service searches for identifying information that may be stored across that user's various networks through public and private APIs, by simulating a normal browser-based search, or by other means, typically assuming the identity of the searching user on each service. Prior to search, the third party service scans the user's computing device, indexes the results and uses the information to return results with the highest-degree of accuracy. The third party service stores the results of these searches in a database. These results are displayed to the user by various means, allowing the user to make actionable decisions based on the information contained therein. The third party service facilitates for its users the creation, deletion, or modification of network relationships with searched-for identifiers of any given network service. The user may make these decisions either before searching by defining default choices, at time of search by choosing actions available on a given network, or at a later time by viewing aggregated reports of search results.

The teachings herein provide a system or method for managing information for social networks, contact databases and other databases containing personal, medical or business information, by deploying a web-based search of multiple protected databases so as to retrieve, modify or add information to those networks. The method may include social network users maintaining all social network login information and network assignment preferences, ex: personal, professional, family, etc., in a single database which then enables users a single point of query, modification and action related to their connections. In one embodiment, the user creates an account database which lists name and login information for all of their social networks, contact managers, media-sharing and communications sites and all other password-protected databases. Users then submit queries to the service containing some identifying information (parameters) about an individual, organization, or group, using but not limited to such inputs as smart phones, computers or scanners. The service then finds the matches by simulating a normal browser-based search assuming the identity of the searching user on each network. The service then yields the results for those individuals, organizations, or groups enabling the user to take action by creating, adding, modifying or deleting the entity from one or more databases, in an aggregated but customized fashion. The user may make these decisions either before searching by defining default choices, at time of search by choosing networks or groups of networks, or at a later time by viewing aggregated reports of search results stored for later retrieval.

Provided herein is: a system that automates the connection of its users with the users of an arbitrary set of social networks or contact management databases (FIG. 4A) storing its user's account information for an arbitrary set of third party networks (FIG. 4B and FIG. 5); receiving requests from users containing some manner of identifying information (FIG. 21A) in a variety of forms (FIG. 21B) using mobile (FIG. 4C, 8) or other inputs (FIG. 21C) to search across an arbitrary set of social networks for individuals, organizations, or groups; finding relationships between the searching user and the searched-for entity, if any, across an arbitrary set of social networks (FIG. 7); returning a list of such relationships and a list of new possible relationships across social networks (FIG. 6, 8, 9C); and adding to aggregate social network analytics data (FIG. 8, 9A, 9B). A method for searching an arbitrary set of social networks for a given individual, organization, or group: receiving from the searching user, some manner of identifying information for an individual, organization, or group (FIG. 21A, 21B, 21C); Executing privately available searches across arbitrary social networks by assuming the searching user's identity and/or simulating a human interaction with the browser-based interface to an arbitrary social network (FIG. 10A); executing publicly available searches across arbitrary social networks (FIG. 10B); or, executing both publicly and privately available searches across arbitrary social networks (FIG. 10C); creating human-like interactions by automating browser-based input and randomizing the timing, source, and content of those inputs (FIG. 11); parsing the results of these searches; and presenting actionable decisions to the searching user based on search results (FIG. 6, 8).

A design for a system capable of automating the search for users of arbitrary social networks: a client application that stores registered users in a database; and a database that stores the account information for the set of social networks to which each registered user belongs. The system or method which further compromises facilitating the user's management of those relationships given their identification information (FIG. 5) and their user profile (FIG. 13), specifically insofar as addition into existing networks (FIG. 14): modification of relationship within a network (FIG. 15); joining of new network (FIG. 16); deletion of participation in network (FIG. 17); storing of network information (FIG. 18). The system or method which further compromises facilitating the user's aggregate search, retrieval and management (FIGS. 14, 15) of purchasing, inventory, shipping, production, project management, revenue and expense information based on stored identification information, preferences and profile (FIGS. 19,20), specifically insofar as checking and managing availability information (FIG. 22) receiving and managing pricing information (FIG. 23) checking and managing order information (FIG. 24) checking and managing shipping information (FIG. 25) checking and managing sales information (FIG. 26) checking and managing manufacturing status information (FIG. 27) checking and managing expenses information (FIG. 28) checking and managing project management information (FIG. 29) storing of search results.

By having a way to search all of one's preferred password-protected databases at once, users will be able to quickly and easily add new and existing connections to all the networks of relevance, at once. Users will no longer worry about remembering to add new connections and their contact information to important databases. Users will no longer forget the databases to which they may want to add an entity. In mapping one's social graph with a new connection, one can determine areas of overlap and areas of distinction, providing further insights and opportunities to expand one's network. In other embodiments the method or system disclosed herein may gather information pertinent in any given search through: (a) public web, the method may aggregate data from a standard web search; (b) private web scraping, the method may search behind password protected databases, a process known to those of skill in the art as using scripts to scrape data from websites by logging in as that user, with their permission, (c) private web through Application Programming Interface (API), the method may search through password protected databases using the ‘API’ made available by the provider; and (d) private web, the method may through uniquely granted access (FIGS. 6A, 10 and 6).

In another application, the teachings herein provides a method by which management professionals may maintain all information system login information and preferences, ex: shipping location, payment information, etc., in a single database which then enables users a single point of query, modification and action related to their specific business networks (FIGS. 19, 20 and 22-29).

In one embodiment, the user creates an account database which lists name and login information for all of their supplier databases, shipping vendors, distribution and manufacturing facilities and all other password-protected databases. Users then submit queries to the service containing some identifying information (parameters) about a product or service, company or project, using but not limited to such inputs as smart phones, computers or scanners. The service then finds the matches by simulating a normal browser-based search assuming the identity of the searching-user on each network. The service then yields the results for those parameters, enabling the user to take action by creating, adding, modifying or deleting that parameter from one or more databases, in an aggregated but customized fashion (FIGS. 19, 20 and 22-29).

In embodiments where the method or system gathers information pertinent in a search are retrieved through private web through the ‘API’, the method may search through password protected databases using the ‘API’ made available by the provider, whereby the user creates an account database which lists name and login information for all their social networks. Users then submit queries to the service containing some identifying information (parameters) about a contact or person, using but not limited to such inputs as smart phones, computers or scanners. Prior to search, the service may scan the user's computing device indexing its contents for relevant information in order to yield results of a highest-degree of accuracy. The service then finds the matches by accessing information through the ‘API’. The service then yields the results for those parameters, enabling the user to take action by creating, adding, modifying or deleting that parameter from one or more databases (FIG. 10C).

In embodiments where the method or system gathers information pertinent in a search are retrieved through private web, the method may, through uniquely granted access, allows for access to and searching of the private web. In this embodiment the method or system accesses social media databases, including FACEBOOK, LINKEDIN, TWITTER, among others as are known in the art, information that may not be accessible to others through their ‘API’ (FIG. 10C).

In another embodiment of the method, provided for is a web-based contact management or customer relations management (CRM) containing contact information of a user with multiple affiliations, such affiliations include but are not limited to social media databases, as are known in the art, but also include contact databases such as Outlook, Salesforce, Google Contacts or Plaxo. In this embodiment the method provides users the ability to search and retrieve all possible information, from real-time social information to stored contact management, CRM and ERP information, from all or a portion of public and private database sources. Whereas presently each private and public data sources have bits and pieces of information on a given person, this method pulls from those disparate sources to yield a comprehensive record of information. Once collected, the method enables the stored results to be uploaded so as to enable synchronized data dissemination into a user's private databases (FIG. 6B).

In another embodiment of the method, provided for is an indexing mechanism which enables the user to yield searches with the highest probability of success. This is especially valuable as searches are executed by name or on the public web, whereby a search, for example, for John Smith yields several hundred thousand results. Prior to executing a search, the service may scan the user's computing device indexing its contents for relevant information on the exact John Smith in question, or for similarities in the user's keyword profile, in order to yield search results of the highest-degree of accuracy and present the exact John Smith in question. Whereas presently social networks factor in one's employment/education history and overlaps in users' social graph, typically collected as part of that social network profile, this method will search deeper for keywords and like associations by scanning documents, files, bookmarks, emails, presentations, video tags and other such sources resident on the user's computer devices or within the public or private web. As an example, but not limited to this scenario, if the user desktop search yields bookmark or PDF information about his bicycling interests and John Smith writes a blog for bicycling enthusiasts, then John Smith the Blogger might appear higher in search results. If the two have exchanged emails, results will have a greater degree of certainty. In this manor, a user will be able to leverage the deeper associations found by indexing their computing devices for keywords and associations (FIG. 7).

The present system or method provides for gathering of real-time, 3-dimensional information on a given person from all reaches of the Internet to enable vastly greater prospecting of sales leads and responsiveness to current contacts as a contact management or CRM system. The system or method for contact management or CRM provides for real-time integrated email, task management, prospect probability and project management tools. The present system or method which enables a user to pull information from a variety of arbitrary databases may also enable a real-time push of information to a variety of arbitrary databases in the form of status updates or email correspondences. As such, methods for marketing and pushing out information become of vital importance (FIG. 10D).

In another embodiment the system or method can be used in medical applications. Provided herein is a tool that enables a record holder to store password information on multiple arbitrary databases, it can also provide that a patient, or designee, may record password information to gain access, or grant access, to multiple arbitrary databases to report on medical history. The system or method which further compromises facilitating the user's aggregate search, retrieval and management (FIGS. 30A and 30B) of medical history, specifically insofar as retrieving one's personal medical visit information, diagnosis, prognosis, medications prescribed, recommendations made, tests taken, test results, follow-up suggested, costs incurred, costs covered by insurance, cost to the patient, invoices sent and payments received.

### BRIEF DESCRIPTION OF THE DRAWINGS

Further features of the teachings herein, their nature and various advantages will be more apparent from the following detailed description, taken in conjunction with the accompanying drawings in which like reference characters refer to like parts throughout, and in which:

FIG. 1 is a functional block diagram of an illustrative system in accordance with one embodiment of the teachings herein.

FIG. 2 shows one embodiment of a mobile device that may be included in a system implementing the teachings herein.

FIG. 3 shows one embodiment of a network device that may be included in a system implementing the teachings herein.

FIG. 4A is a flow chart for a process for managing information for social networks in accordance with one embodiment of the teachings herein.

FIG. 4B is a flow chart for a process for managing information for social networks in accordance with one embodiment of the teachings herein.

FIG. 4C is a flow chart for a process for managing information for social networks in accordance with one embodiment of the teachings herein.

FIG. 5 shows a data scheme for managing information for social networks in accordance with one embodiment of the teachings herein.

FIG. 6A is a flow chart for a process for managing information for social networks in accordance with one embodiment of the teachings herein.

FIG. 6B is a flow chart for data synchronization in accordance with one embodiment of the teachings herein.

FIG. 6C is a flow chart for synchronized data dissemination in accordance with one embodiment of the teachings herein.

FIG. 6D shows a user interface for managing information for social networks in accordance with one embodiment of the teachings herein.

FIG. 7 is a flow chart for an indexing mechanism in accordance with one of the embodiments disclosed herein.

FIG. 8 shows a user interface for managing information for social networks in accordance with one embodiment of the teachings herein.

FIG. 9A shows a user interface for managing information for social networks in accordance with one embodiment of the teachings herein.

FIG. 9B shows a user interface for managing information for social networks in accordance with one embodiment of the teachings herein.

FIG. 9C shows a user interface for managing information for social networks in accordance with one embodiment of the teachings herein.

FIG. 9D shows a data scheme for managing information for social networks in accordance with one embodiment of the teachings herein.

FIGS. 10A-D shows embodiments of flow charts for processes for managing information for social networks in accordance with the teachings herein.

FIG. 11 shows a sample software code in accordance with one embodiment of the teachings herein.

FIG. 12 is a flow chart for a process for managing information for social networks in accordance with one embodiment of the teachings herein.

FIG. 13 shows a user interface for managing information for social networks in accordance with one embodiment of the teachings herein.

FIG. 14 is a flow chart for a process for managing information for social networks in accordance with one embodiment of the teachings herein.

FIG. 15 is a flow chart for a process for managing information for social networks in accordance with one embodiment of the teachings herein.

FIG. 16 is a flow chart for a process for managing information for social networks in accordance with one embodiment of the teachings herein.

FIG. 17 is a flow chart for a process for managing information for social networks in accordance with one embodiment of the teachings herein.

FIG. 18 is a flow chart for a process for managing information for social networks in accordance with one embodiment of the teachings herein.

FIG. 19 shows a data scheme for managing information for social networks in accordance with one embodiment of the teachings herein.

FIG. 20 shows a data scheme for managing information for social networks in accordance with one embodiment of the teachings herein.

FIGS. 21A-C show lists of examples in accordance with one embodiment of the teachings herein.

FIG. 22 is a flow chart for a process for managing information for social networks in accordance with one embodiment of the teachings herein.

FIG. 23 is a flow chart for a process for managing information for social networks in accordance with one embodiment of the teachings herein.

FIG. 24 is a flow chart for a process for managing information for social networks in accordance with one embodiment of the teachings herein.

FIG. 25 is a flow chart for a process for managing information for social networks in accordance with one embodiment of the teachings herein.

FIG. 26 is a flow chart for a process for managing information for social networks in accordance with one embodiment of the teachings herein.

FIG. 27 is a flow chart for a process for managing information for social networks in accordance with one embodiment of the teachings herein.

FIG. 28 is a flow chart for a process for managing information for social networks in accordance with one embodiment of the teachings herein.

FIG. 29 is a flow chart for a process for managing information for social networks in accordance with one embodiment of the teachings herein.

FIGS. 30A and 30B shows a block diagram of the use of one embodiment described herein for medical records and history and the owner's and providers of the records.

### DETAILED DESCRIPTION OF THE INVENTION

The teachings herein will be described more fully hereinafter with reference to the accompanying drawings, which form a part hereof, and which show, by way of illustration, specific exemplary embodiments by which the teachings herein may be practiced. The teachings herein may, however, be embodied in many different forms and should not be construed as limited to the embodiments set forth herein; rather, these embodiments are provided so that this disclosure will be thorough and complete, and will fully convey the scope of the teachings herein to those skilled in the art. Among other things, the teachings herein may be embodied as methods or devices. Accordingly, the teachings herein may take the form of an entirely hardware embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, although it may. Thus, as described below, various embodiments of the teachings herein may be readily combined, without 20 departing from the scope or spirit of the teachings herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a”, “an,” and “the” includes plural references. The meaning of “in” includes “in” and “on.”

Network information is stored for different services in different private databases. Users of a particular service may search, through documented APIs, web interfaces, or other means, that service's database for social network information, typically providing account credentials to authenticate themselves in order to gain search results. This invention enables users store their various network credentials in a third party service. Users of this third party service may submit queries to the service containing some identifying information about an individual, organization, or group; or identifying information about a product or service; or similarly stored private data. The third party service searches for identifying information that may be stored across that user's various networks through public and private APIs, by simulating a normal browser-based search, or by other means, typically assuming the identity of the searching user on each service. The third party service stores the results of these searches in a database. These results are displayed to the user by various means, allowing the user to make actionable decisions based on the information contained therein. The third party service facilitates for its users the creation, deletion, or modification of network relationships with searched-for identifiers of any given network service. The user may make these decisions either before searching by defining default choices, at time of search by choosing actions available on a given network, or at a later time by viewing aggregated reports of search results.

As used herein, the terms “social network” and “social graph” refer to any mapping, description, or information containing a representation of an individual's personal network of friends, family, colleagues, coworkers, or students, as well as the subsequent connections within those networks. An online social network typically comprises a person's set of direct or indirect personal relationships, including real and virtual privileges and permissions that users may associate with these people. Direct personal relationships usually include relationships with people the user can communicate with directly, including family members, friends, colleagues, coworkers, and other people with whom the person has had some form of direct contact with, such as contact in person, by telephone, by email, by instant message, by letter, or the like.

As used herein “social database” refers to a database of information on multiple contacts that include but is not limited to contact information, such as physical location information, electronic or virtual location information; as well as social network information, such as social network status information, user-generated news feeds, articles, publications or blogs written by the contact or mentioning the contact or their affiliations.

These direct personal relationships are sometimes referred to as first-degree relationships. First degree relationships can have varying degrees of closeness, trust, and other characteristics. Indirect personal relationships typically include relationships through first-degree relationships to people with whom a person has not had some form of direct or limited direct contact, such as being “carbon-copied” on an email message, or the like. For example, a friend of a friend represents an indirect personal relationship. A more extended indirect relationship might be a friend of a friend of a friend. These indirect relationships are sometimes characterized by a degree of separation between the people. For instance, a friend of a friend can be characterized as two degrees of separation or a second-degree relationship. Similarly, a friend of a friend of a friend can be characterized as three degrees of separation or a third-degree relationship. Non-existent personal relationships typically are those where no direct or indirect contact exists.

Briefly stated the teachings herein are directed toward enabling a search for an individual(s), organization or group across all of a user's social networks and protected databases. The aggregated search across all of a user's preferred social networking, communications and content management tools may be provided by employing software and hardware mechanisms that simulate human interaction within each respective database, or by accessing the information through an openly available ‘API’, privately available ‘API’ or public web. The service may search the user's computing device for relevant information before initiating such search so as to order the results by highest-degree of accuracy. The search may be initiated from such devices as a cell phone, smart phone, laptop, desktop computer, voice recorder, video recorder, scanner, or computing device of the similar type. Results may present themselves in table or graph form and may be hyperlinked so as to enable the user to take action within minutes of initiating the search. Results may also be presented through an email or desktop application running report(s) of new connections and may display the automated actions that can be taken for each. This system may enable users to view their entire social network or the way each social network may span their overall social network.

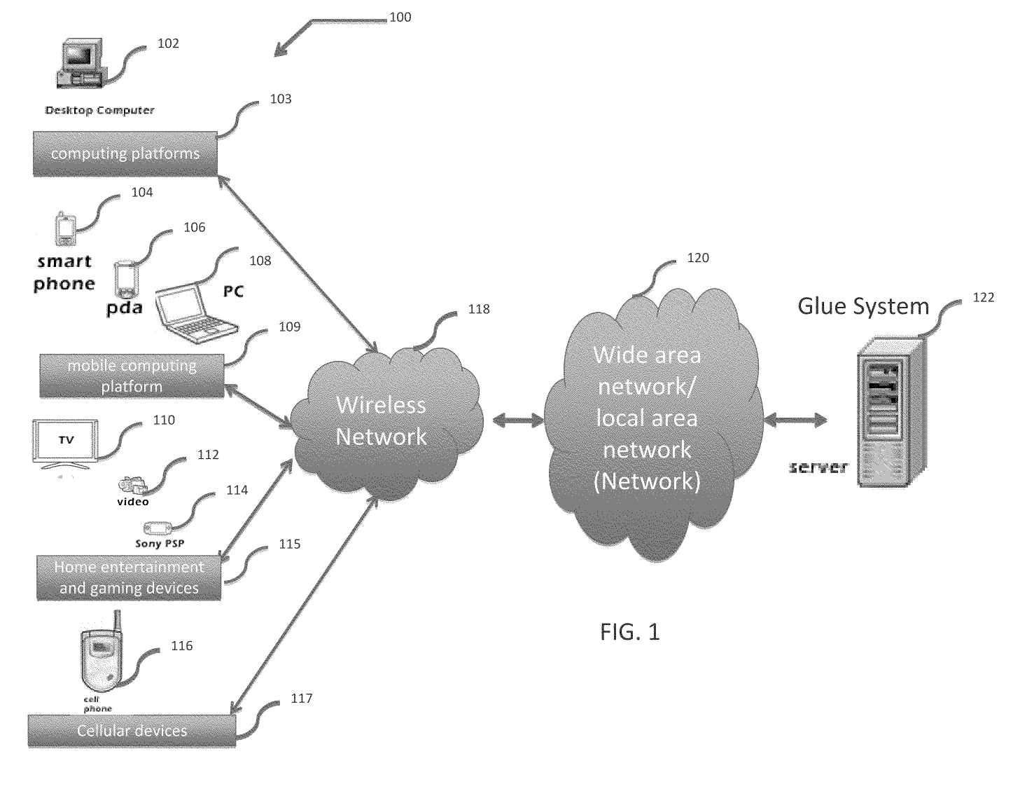

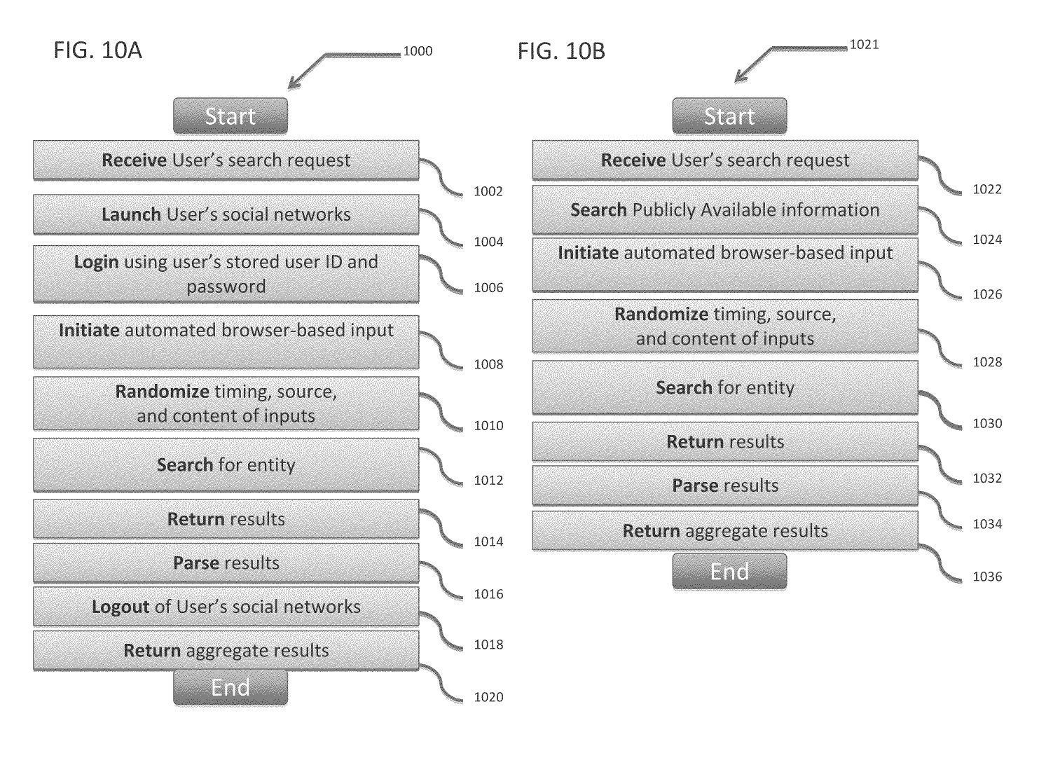

Moreover, by providing mobile users with integrated search and management tool, the user may add new connections to their online social networks and protected database using tools in real-time or through a daily report of new contact activity. In addition, users may create new connections, may modify existing connections or may delete new connections. Illustrative Operating Environment FIG. 1 shows components of one embodiment of an environment in which the teachings herein may be practiced. Not all the components may be required to practice the teachings herein, and variations in the arrangement and type of the components may be made without departing from the spirit or scope of the teachings herein. As shown, system 100 of FIG. 10 includes local area networks (“LANs”)/wide area networks (“WANs”)-(network) 118, wireless network 120, GLUE System 122, mobile devices, home entertainment/gaming devices, cellular phones and computing platforms (client devices) 102-116.

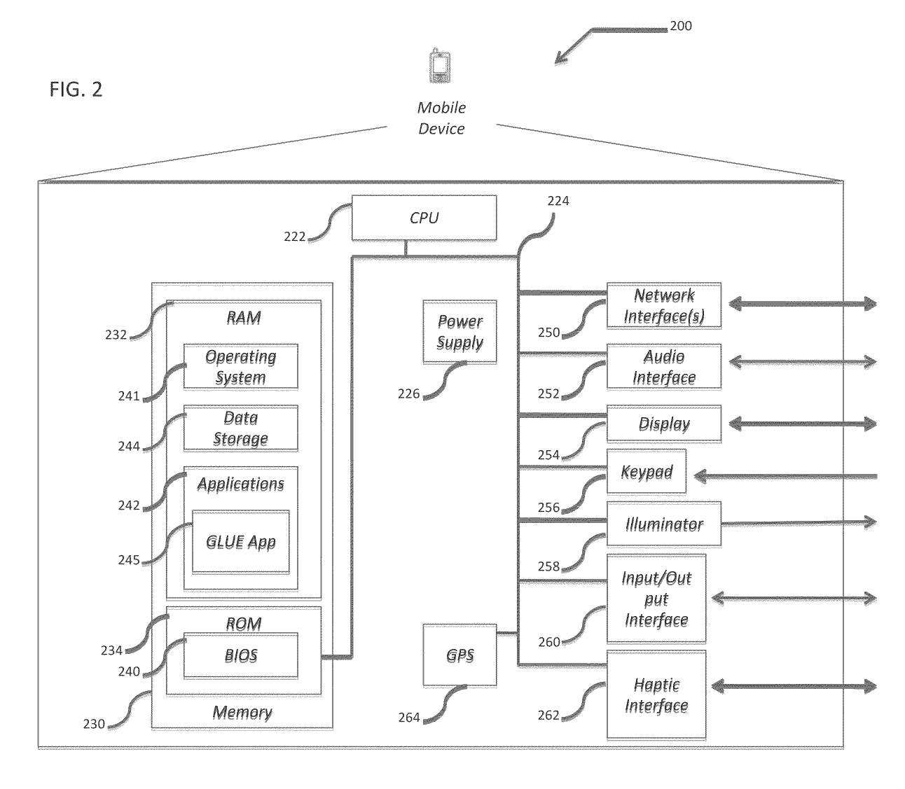

Illustrative Mobile Client Environment FIG. 2 shows one embodiment of mobile device 200 that may be included in a system implementing the teachings herein. Mobile device 200 may include many more or less components than those shown in FIG. 2. However, the components shown are sufficient to disclose an illustrative embodiment for practicing the teachings herein. Mobile device 200 may represent, for example, mobile devices 104-116 of FIG. 1.

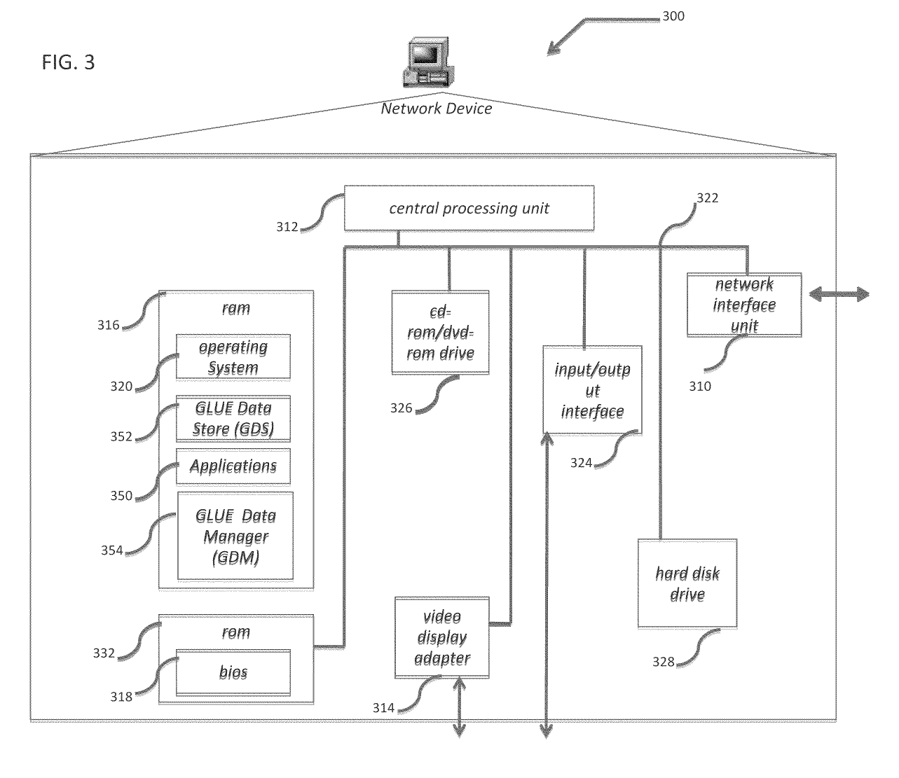

Illustrative Server Environment FIG. 3 shows one embodiment of a network device, according to one embodiment of the teachings herein. Network device 300 may include many more components than those shown.

The components shown, however, are sufficient to disclose an illustrative embodiment for practicing the teachings herein. Network device 300 may represent, for example, GLUE System 122 of FIG. 1.

Generalized Operation

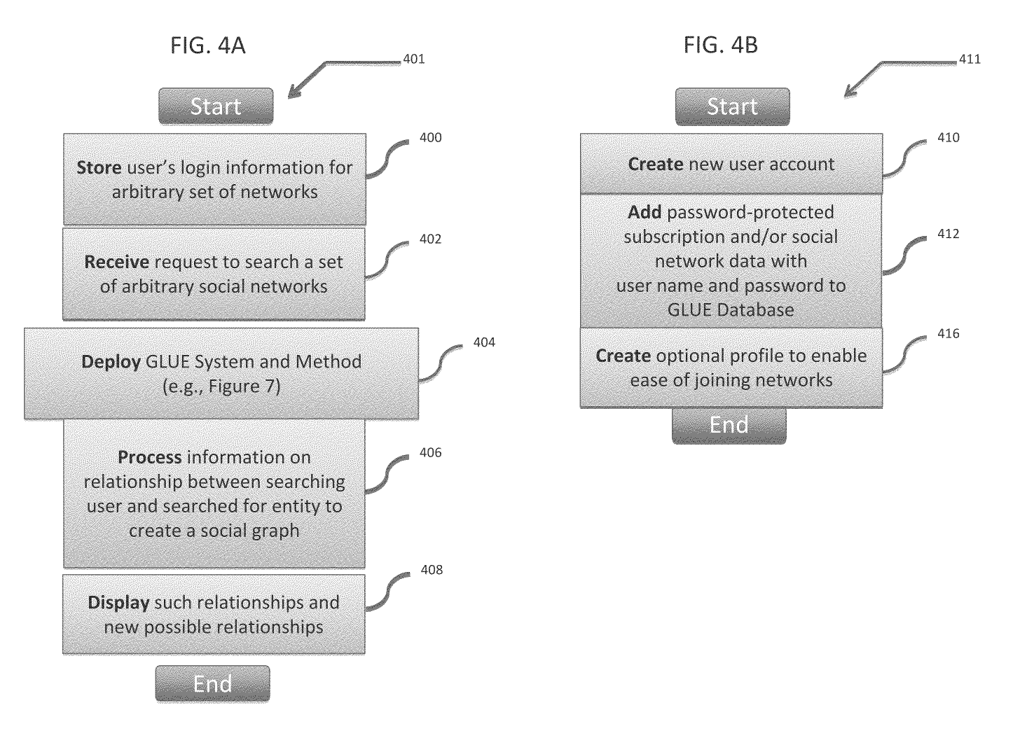

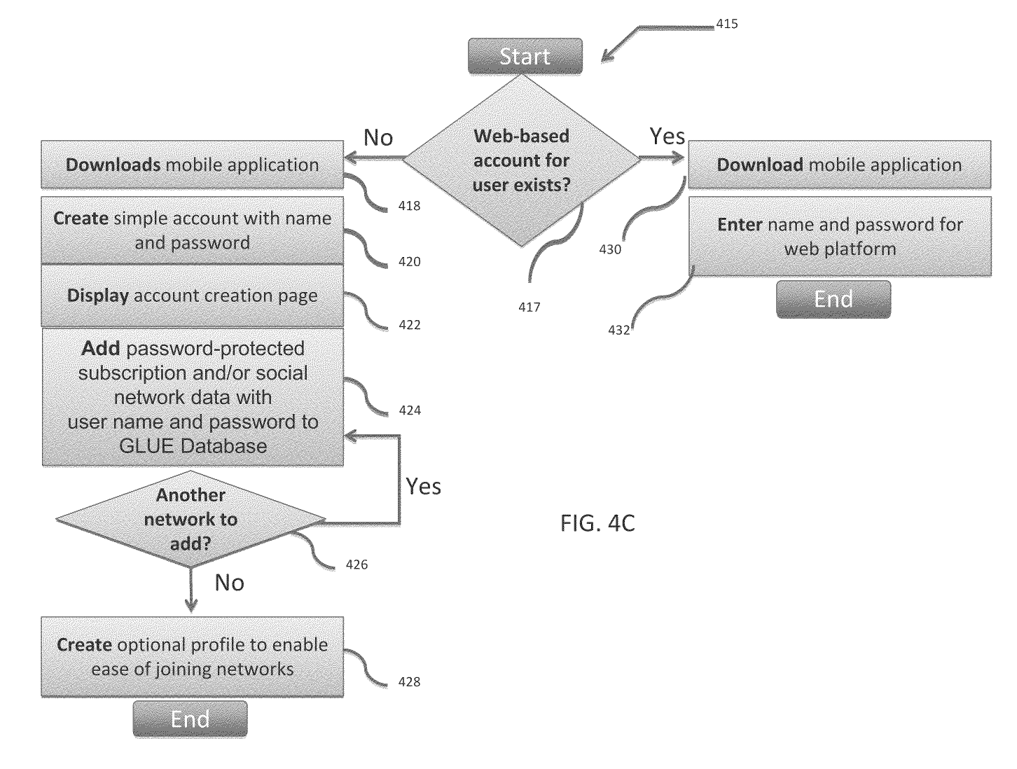

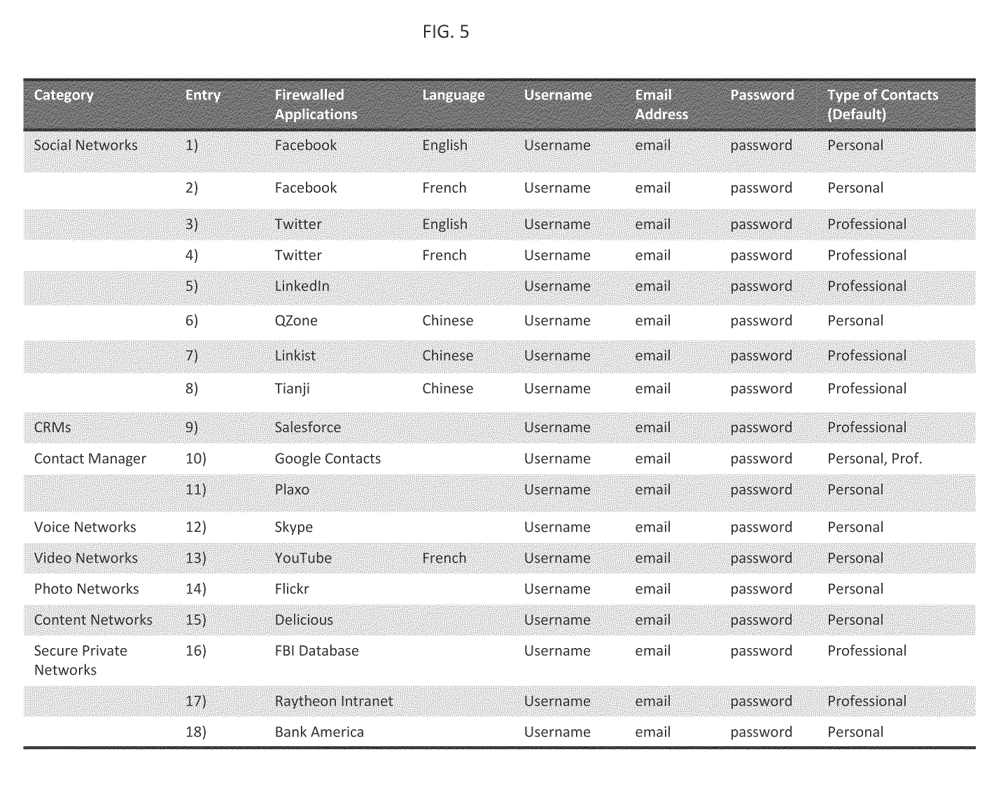

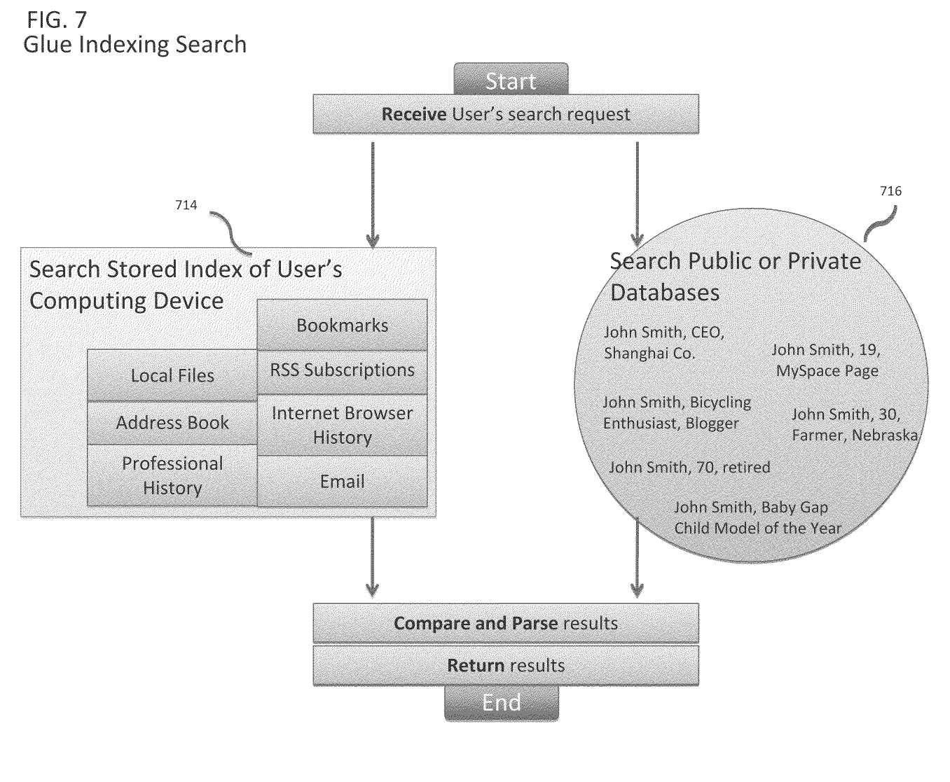

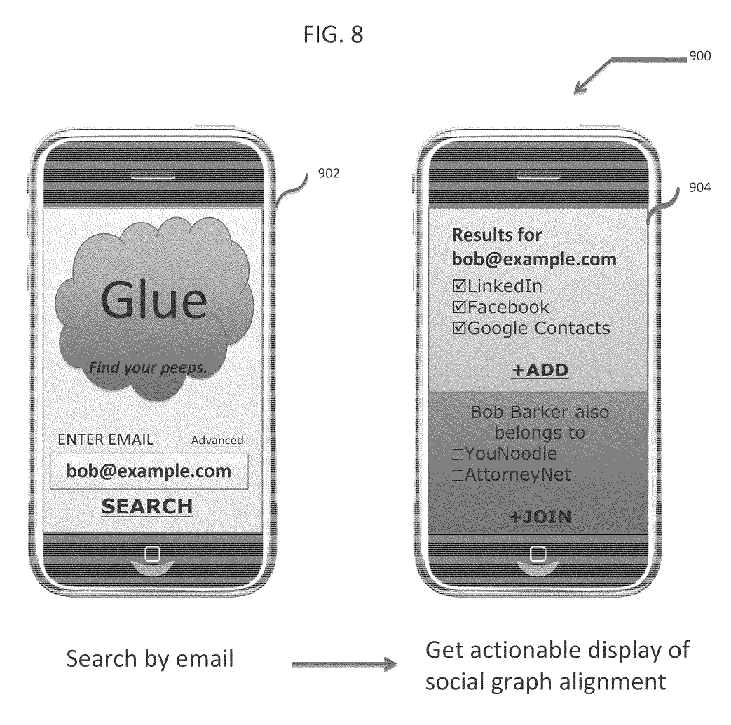

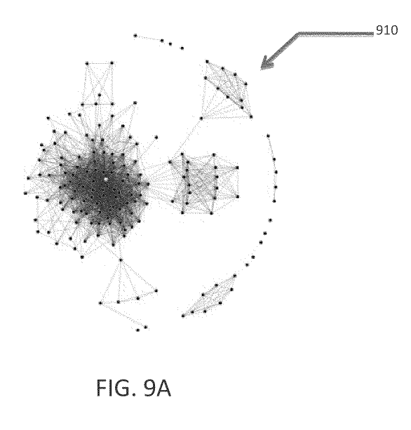

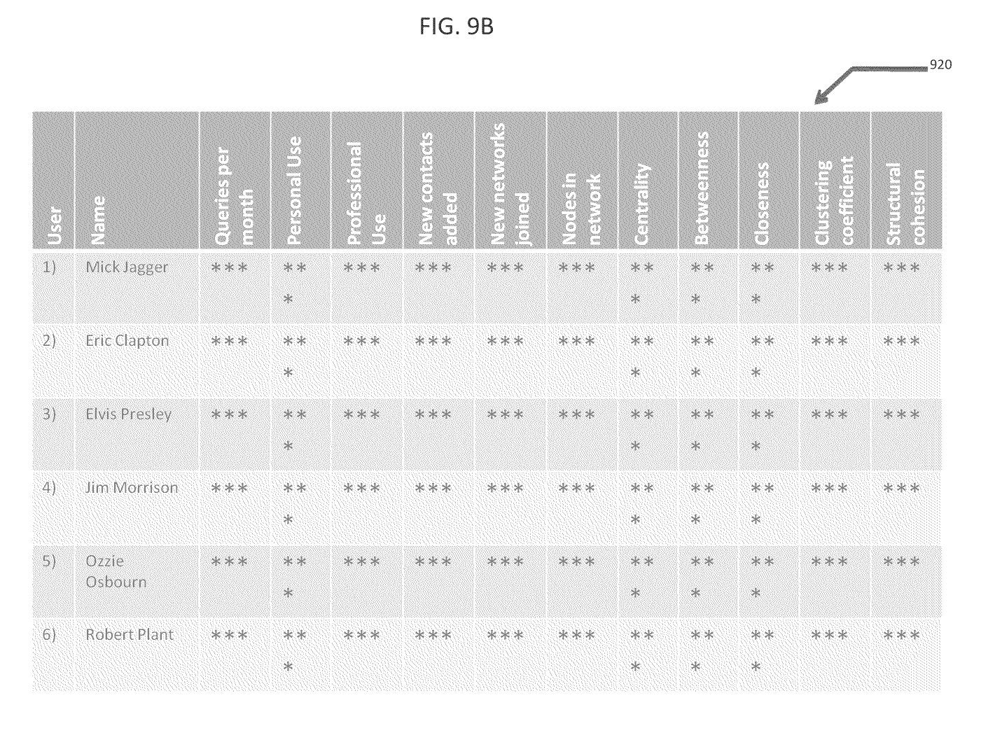

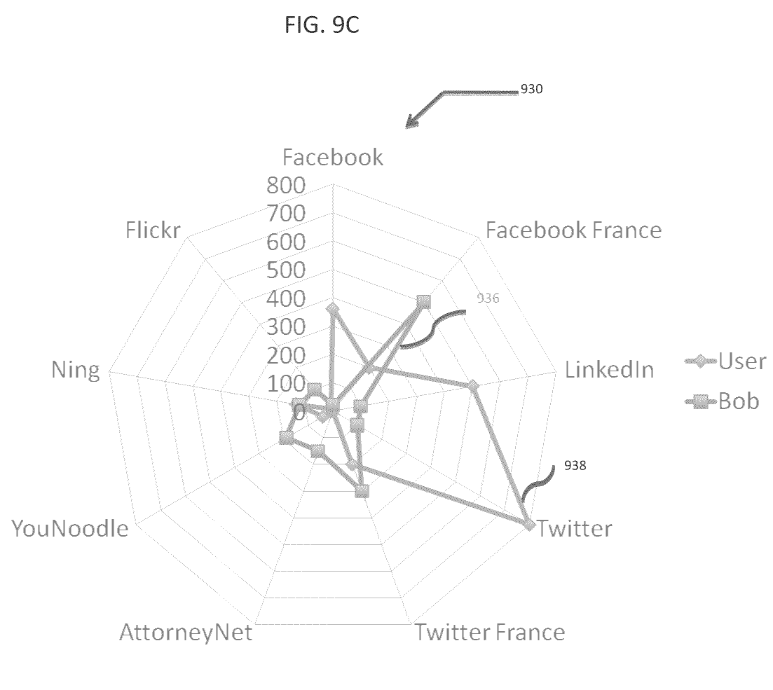

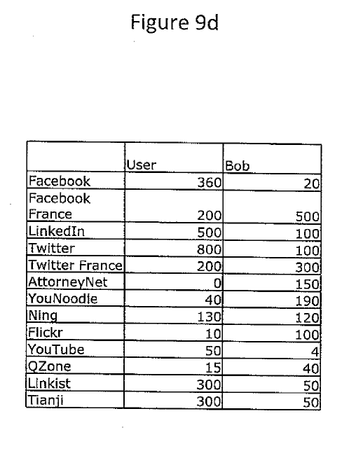

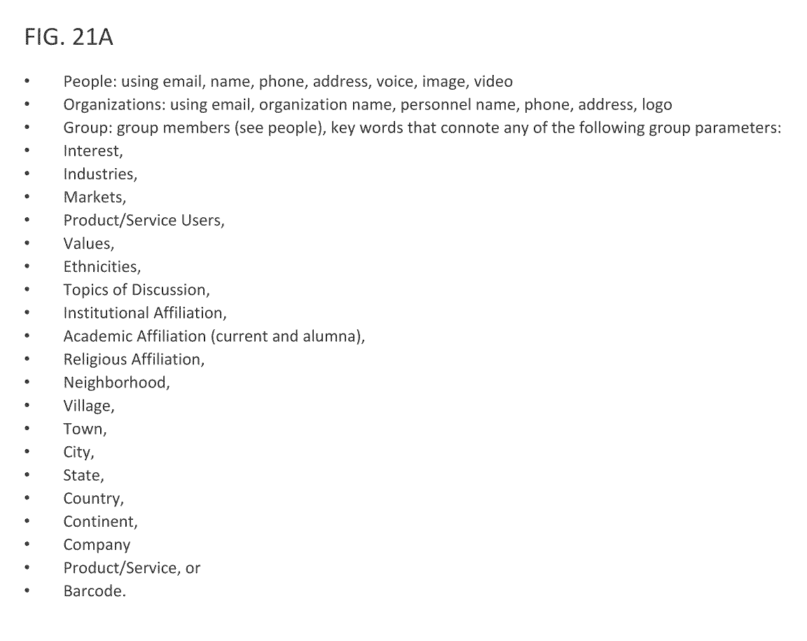

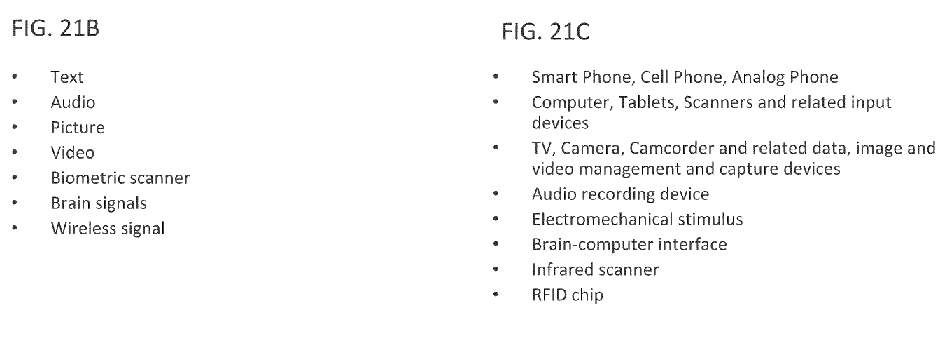

FIG. 4A illustrates a logical flow diagram generally showing one embodiment of a process for managing network information, including the storage of user login information for an arbitrary set of networks, including preference information. Process 401 of FIG. 4A may be implemented within GLUE system of FIG. 1. Process 401 begins, after a start block, at block 400, where user login information for an arbitrary set of networks is stored, including username, password and preferences. In one embodiment, the login information is input from a client device. In another embodiment, the login information is received from a networked device. The process then flows to block 402, where the system may receive a user request to search a set of arbitrary networks for identifying information or parameters, including but not limited to those listed in FIG. 21A. The request may be input using but not limited to the types of devices listed in FIG. 21C. Data received may be of varying type including, but not limited to, those listed on FIG. 21B. The process then flows to block 404, where the GLUE system and method is deployed based in part on user's database record of arbitrary networks and preferences, a software script may begin which logs the GLUE system into the user's multiple private databases, running automated scripts within each as per the user's request and stored profile preferences. The process then flows to block 406 where the results of the automated script actions may be processed on multiple password-protected networks concurrently. The results of each script, and associated possible actions, may then be graphically mapped for ease of interpretation and alignment. Such graphics are embodiment is in the FIGS. 7, 9A and 9C. Another embodiment of the results is a simple list or table. The process then flows to block 408 where resulting graphics and associated actions that may be taken, may be displayed to the user. See FIG. 8 for an embodiment of a mobile search interface and accompanying results of a search.

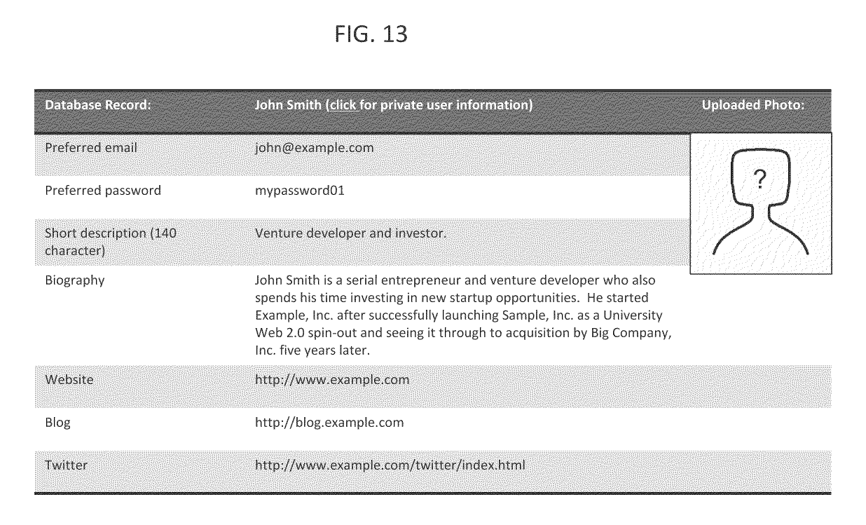

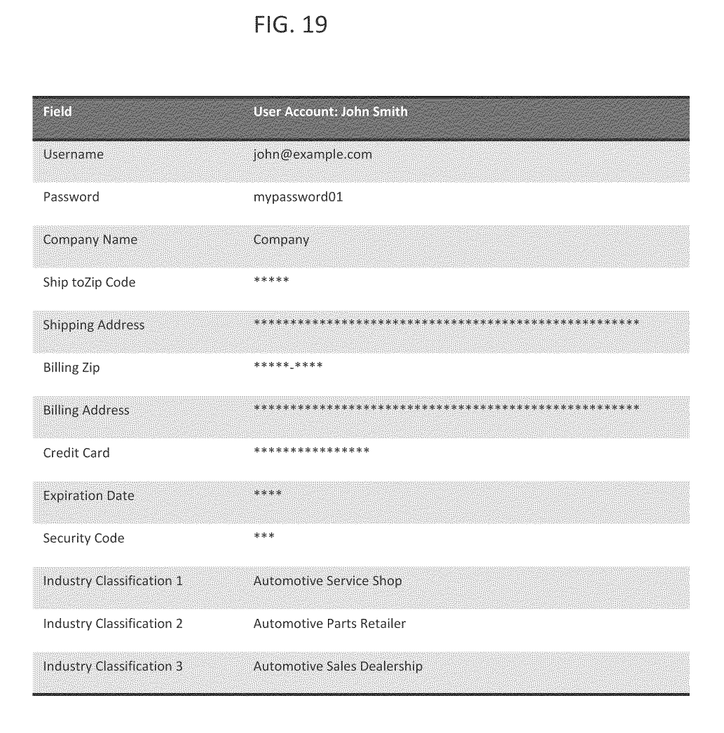

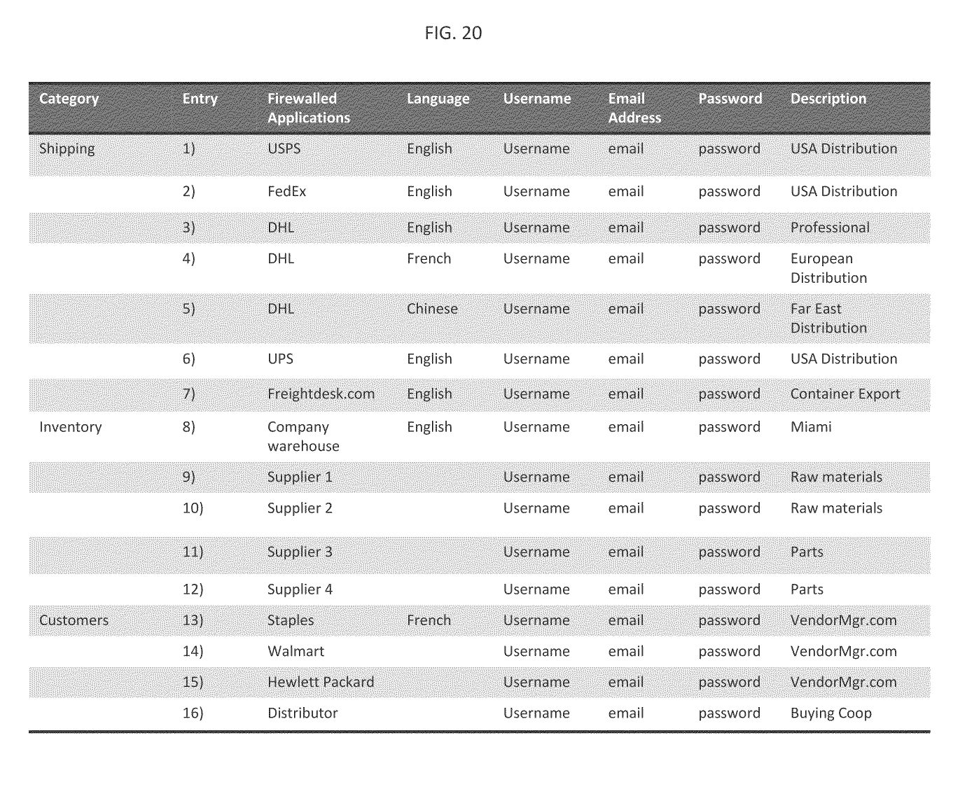

FIG. 4B illustrates a logical flow diagram generally showing one embodiment of a process for enabling a user to create an account which stores their login username and password to an arbitrary set of networks, along with user preferences and profiles. Process 410 of FIG. 4B may be implemented, for example, within a client device. Process 410 may also be implemented on a networked device. The process 411 begins, after a start block, at block 410, where the user creates a new account in the GLUE system. In one embodiment, the user creates such an account for social networking purpose. In another embodiment, the user creates such an account for commercial or management purposes. The process then flows to block 412 where the user inputs a record into the database that possesses the name, location, login credentials (both username and password) and preferences, as it relates to a protected database. Process 412 flows next to a decision block 414, where a determination is made whether to add another network, and associated login information, or otherwise enable the user to begin the use of the GLUE System. One embodiment of a user database record is shown in FIG. 5. Another for company management applications is shown in FIG. 20. The process then flows to 416, where the user may then provide user profile information as shown in one embodiment on FIG. 13 or FIG. 19 so that the user may use the GLUE system for ease of joining new networks revealed in results of GLUE queries.

FIG. 4C illustrates one logical flow diagram generally showing one embodiment of a process for initiating mobile capability that may be used with the GLUE system. Process 415 of FIG. 4C may be implemented within the GLUE System of FIG. 1. See FIG. 8 for an embodiment of a mobile search interface and accompanying results of a search. The process 415 begins after the start block with a decision block 417 where a determination may be made whether a web-based account has already been created from a networked device or whether one can initiate creation from the mobile device. If a web-based account was already created, the process flows to block 430, where the user may download a GLUE mobile application and login using the GLUE name and password they created. The process then flows to 432 where the user enters those credentials into the mobile application the process ends. If at 417 the user has not already created a mobile account, then the process flows to 418 where the user downloads the mobile application. The process then flows to 420 where the user creates an account by assigning a username and password to their GLUE account. The process then flows to 422 where the GLUE mobile application launches a mobile web browser to the GLUE system's web-based account creation page. The process then flows to 424 where the user adds into the GLUE database a password-protected network to which they belong, accompanied by login username and password information. One embodiment of a user database record is shown in FIG. 5. Another for company management applications is shown in FIG. 20. The process then flows to a decision block 426 where a determination is made whether to add another network. If additional networks are to be added, the process then flows back to 424; otherwise, the process continues to block 428 where the user creates an optional profile to enable ease of joining new networks found through GLUE system queries. One embodiment of such a user profile is shown in FIG. 13. Another embodiment for company management applications is FIG. 19.

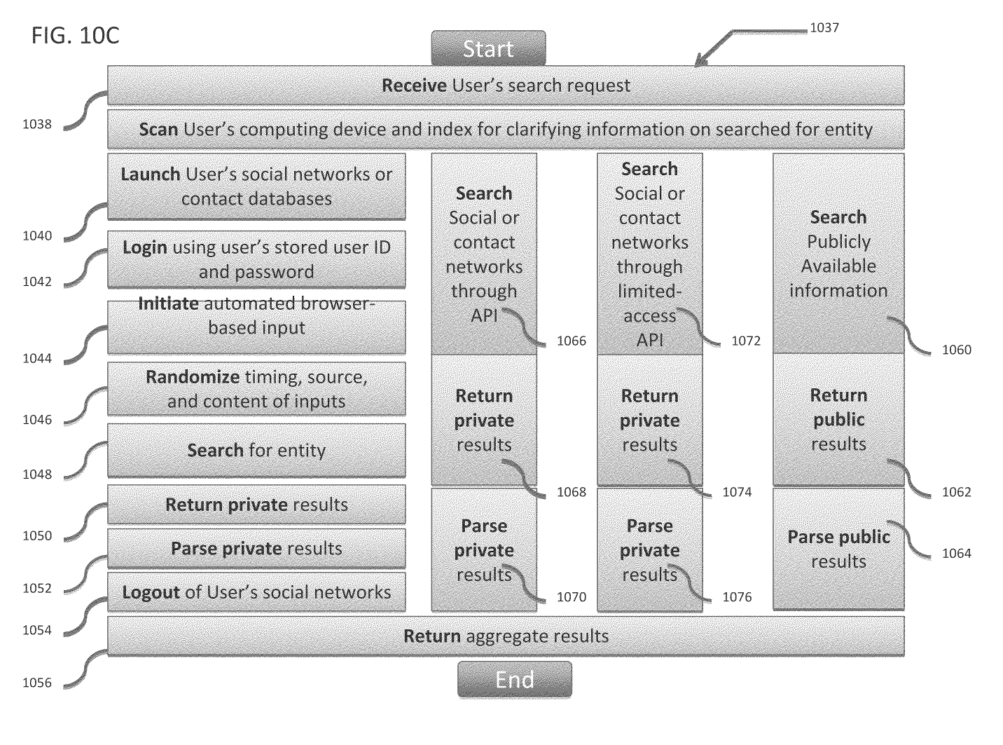

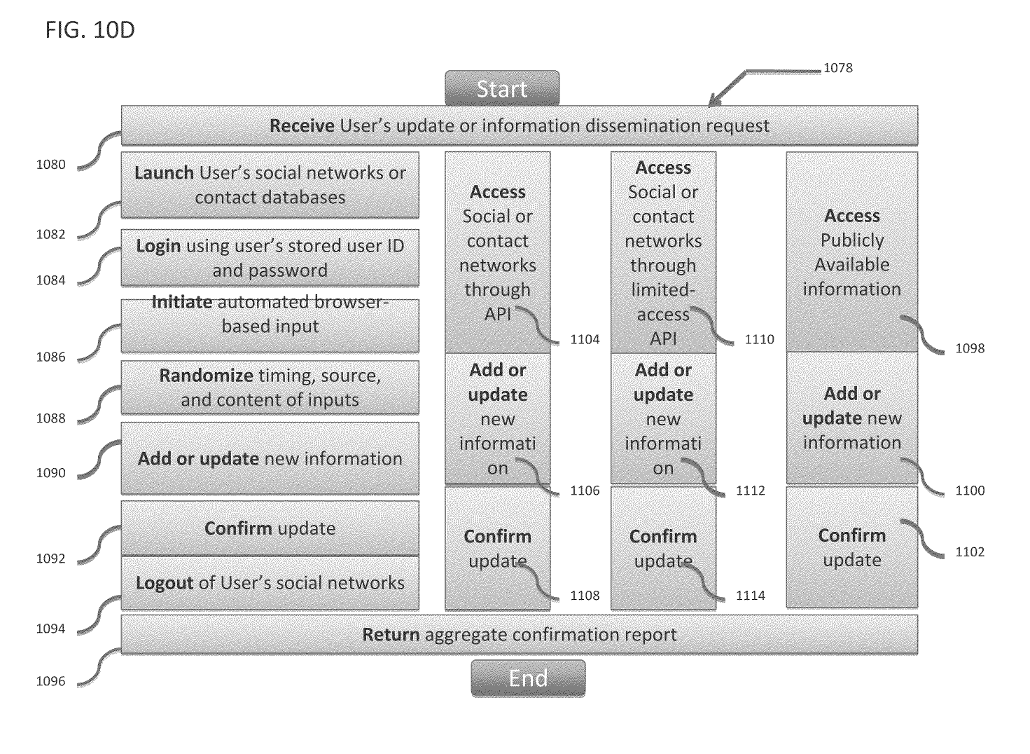

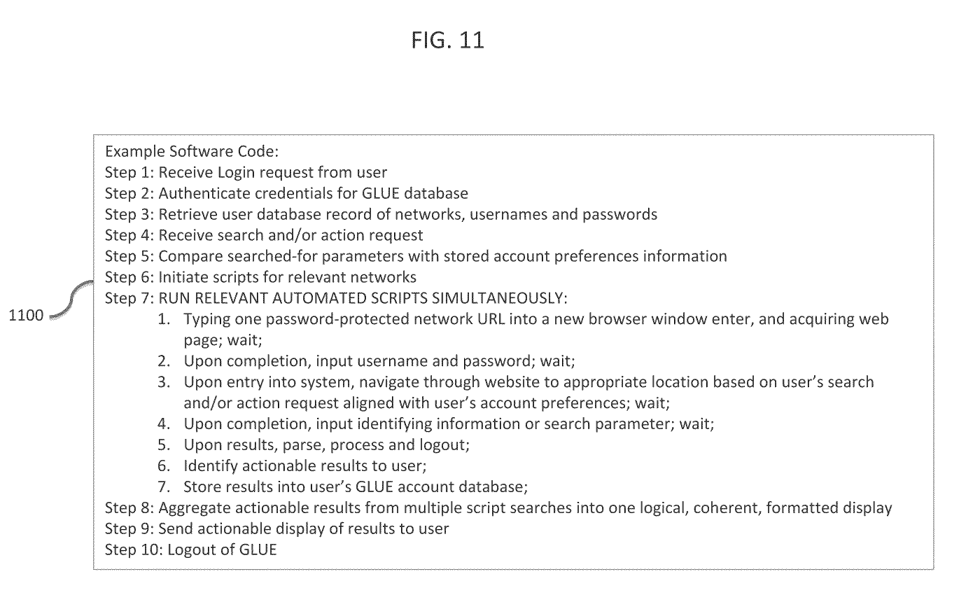

FIG. 10A Illustrates a logical flow diagram generally showing one embodiment of a process for conducting a search through private, password protected databases based on the creation of a user account which may have been created on a client computer or a mobile device. Process 1000 of FIG. 10A maybe initiated from the client devices on FIG. 1, a web-based desktop computer, or any other input device shown on FIG. 1. The process 1000 begins after a start block, at block 1002 when the system receives a user's search request. The process flows to 1004 where the system launches the stored arbitrary networks in the user account database, applying the stored user preferences. The process flows to 1006 where the system retrieves user name and password information and inputs them into the launched networks. The process then flows to 1008 where the system runs a script designed for that network. One embodiment of a software script is shown in FIG. 11. The script automates the entry of requested information as per the user's request in 1002. The process then flows to 1010 where the script may appropriately apply a specified combination of randomized timing, source and content of the data inputs into the password-protected databases in order to mimic human behavior. The process then flows to 1012 where the script may initiate a search within the database. The process then flows to 1014 where the search may yield results. The process then flows to 1016 where the results may be parsed. The process then flows to 1018 where the system logs out of the user's network. The process then flows to 1020 where the query results of multiple search results, if applicable, may be aggregated.

FIG. 10B illustrates a logical flow diagram generally showing one embodiment of a process for conducing a search through public databases based on the creation of a user account. Process 1021 may be initiated from the client devices on FIG. 1, a web-based desktop computer, or any other input device shown on FIG. 1. The process 1021 begins after a start block with 1022 where the system may receive a user search request. The process flows to 1024 where the system may search all publicly available information. Such sources may include, but is not limited to, publicly available information on contact data, organizational information, as well as product or service data. The process flows to 1026 where the system may initiate automated browser-based input. The process flows to 1028 where the system randomizes the timing, source and content of inputs so as to mimic human behavior. The process then flows to 1030 where the system search may yield results. The process then flows to 1032 where the results may be returned. The process then flows to 1034 where the results may be parsed. The process then flows to 1036 where the query results of multiple search results, if applicable, may be aggregated.

FIG. 10C illustrates a logical flow diagram generally showing one embodiment of a process for conducing a search through private password-protected databases and public databases simultaneously, based on the creation of a user account which may have been created on a client computer or a mobile device. Process 1037 of FIG. 10A may be initiated from the client devices on FIG. 1, a web-based desktop computer, or any other input device shown on FIG. 1. In embodiments where the method or system gathers information pertinent in a search are retrieved through private web, the method may, through uniquely granted access, allows for access to and searching of the private web. In this embodiment the method or system accesses social media databases, including FACEBOOK, LINKEDIN, TWITTER, among others as are known in the art, information that may not be accessible to others through their ‘API’ (FIG. 10C).

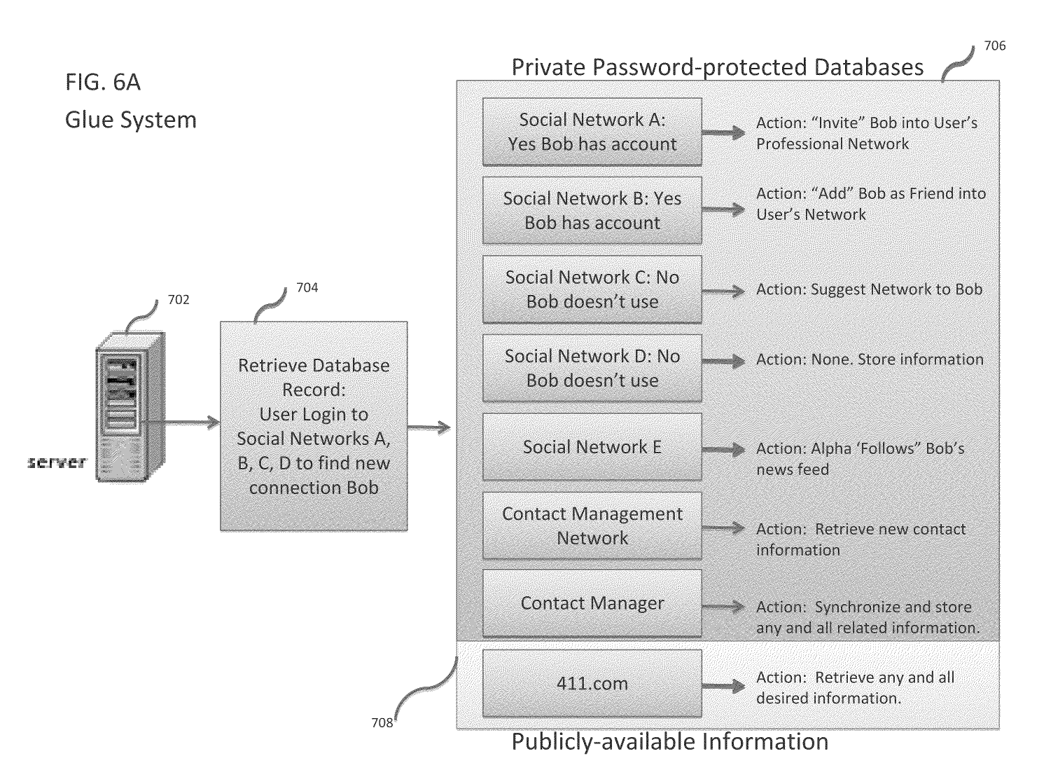

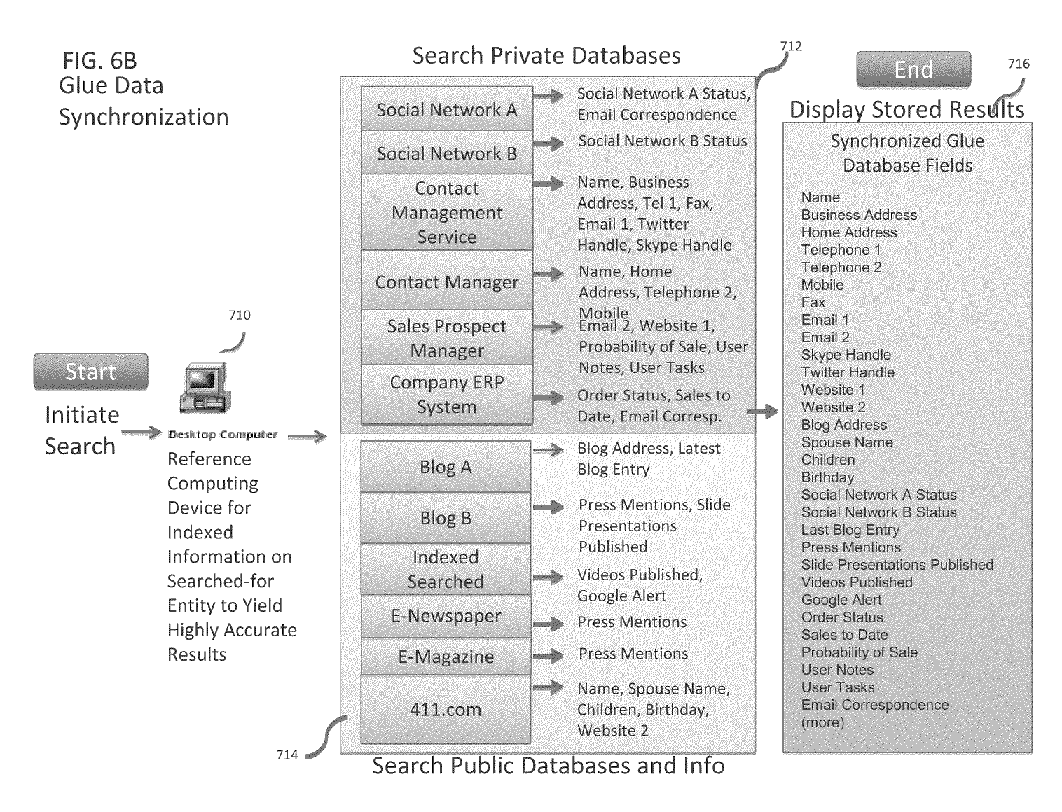

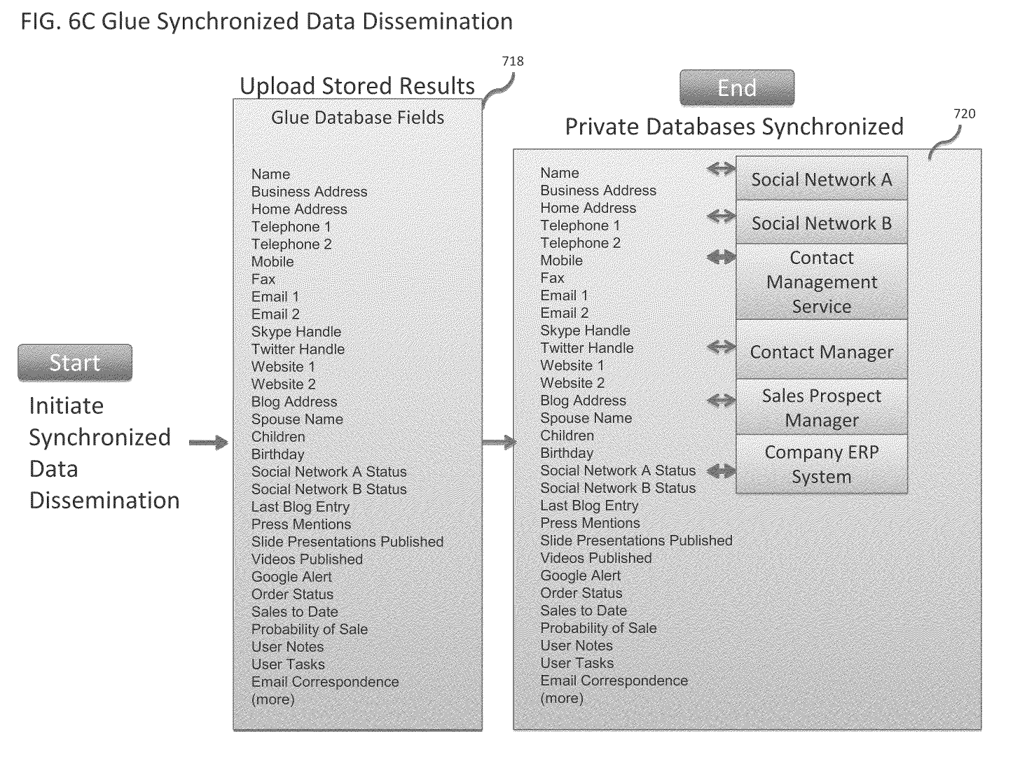

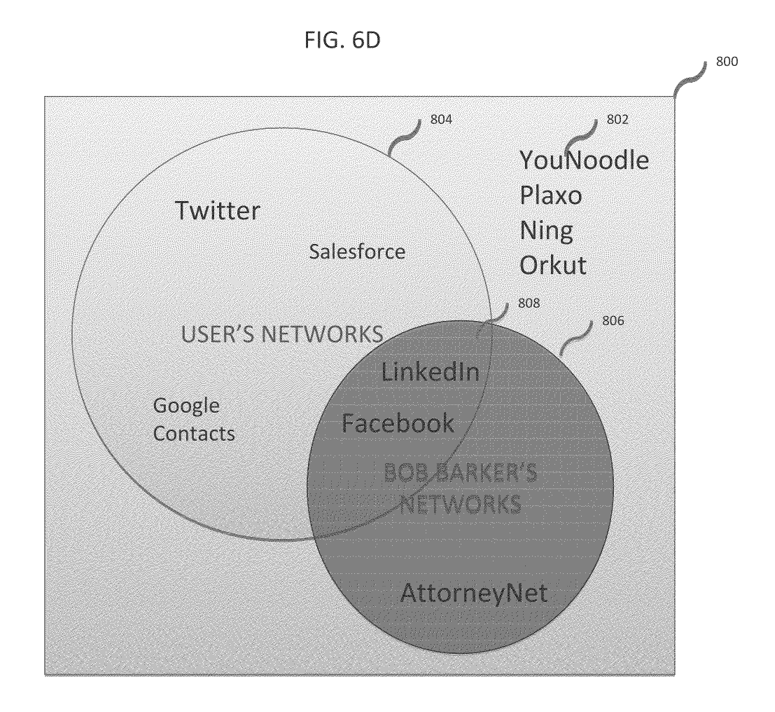

In another embodiment of the method, provided for is a web-based contact management or customer relations management (CRM) containing contact information of a user with multiple affiliations, such affiliations include but are not limited to social media databases, as are known in the art, but also include contact databases such as Outlook, Salesforce, Google Contacts or Plaxo. In this embodiment the method provides users the ability to search and retrieve all possible information, from real-time social information to stored contact management, CRM and ERP information, from all or a portion of public and private database sources. Whereas presently each private and public data sources have bits and pieces of information on a given person, this method pulls from those disparate sources to yield a comprehensive record of information. Once collected, the method enables the stored results to be uploaded so as to enable synchronized data dissemination into a user's private databases (FIG. 6B).

In another embodiment of the method, provided for is an indexing mechanism which enables the user to yield searches with the highest probability of success. This is especially valuable as searches are executed by name or on the public web, whereby a search, for example, for John Smith yields several hundred thousand results. Prior to executing a search, the service may scan the user's computing device indexing its contents for relevant information on the exact John Smith in question, or for similarities in the user's keyword profile, in order to yield search results of the highest-degree of accuracy and present the exact John Smith in question. Whereas presently social networks factor in one's employment/education history and overlaps in users' social graph, typically collected as part of that social network profile, this method will search deeper for keywords and like associations by scanning documents, files, bookmarks, emails, presentations, video tags and other such sources resident on the user's computer devices or within the public or private web. As an example, but not limited to this scenario, if the user desktop search yields bookmark or PDF information about his bicycling interests and John Smith writes a blog for bicycling enthusiasts, then John Smith the Blogger might appear higher in search results. If the two have exchanged emails, results will have a greater degree of certainty. In this manor, a user will be able to leverage the deeper associations found by indexing their computing devices for keywords and associations (FIG. 7).

The present system or method provides for gathering of real-time, 3-dimensional information on a given person from all reaches of the Internet to enable vastly greater prospecting of sales leads and responsiveness to current contacts as a contact management or CRM system. The system or method for contact management or CRM provides for real-time integrated email, task management, prospect probability and project management tools. The present system or method which enables a user to pull information from a variety of arbitrary databases may also enable a real-time push of information to a variety of arbitrary databases in the form of status updates or email correspondences. As such, methods for marketing and pushing out information become of vital importance (FIG. 10D).

FIG. 6D shows one embodiment of the actionable results that may be yielded from such a search. The process 1037 begins after a start block, at block 1038 when the system receives a user's search request. The process flows to two simultaneous paths 1040 to initiate the private search and 1060 to initiate the public search, where the system searches all publicly available information. Such sources may include, but is not limited to, publicly available information on contact data, organizational information, as well as product or service data. The process then flows to 1062 where the results may be returned. The process then flows to 1064 where the results may be parsed. On a parallel path, block 1038 which may have received a user search request also flowed to 1040 where the system launches the user's stored network information. The process then flows to 1042 where the system retrieves user name and password information and inputs them into the launched networks. The process then flows to 1044 where the system runs a script designed for that network.

In another embodiment of the method, provided for is an indexing mechanism which enables the user to yield searches with the highest probability of success. This is especially valuable as searches are executed by name or on the public web, whereby a search, for example, for John Smith yields several hundred thousand results. Prior to executing a search, the service may scan the user's computing device indexing its contents for relevant information on the exact John Smith in question, or for similarities in the user's keyword profile, in order to yield search results of the highest-degree of accuracy and present the exact John Smith in question. Whereas presently social networks factor in one's employment/education history and overlaps in users' social graph, typically collected as part of that social network profile, this method will search deeper for keywords and like associations by scanning documents, files, bookmarks, emails, presentations, video tags and other such sources resident on the user's computer devices or within the public or private web. As an example, but not limited to this scenario, if the user desktop search yields bookmark or PDF information about his bicycling interests and John Smith writes a blog for bicycling enthusiasts, then John Smith the Blogger might appear higher in search results. If the two have exchanged emails, results will have a greater degree of certainty. In this manor, a user will be able to leverage the deeper associations found by indexing their computing devices for keywords and associations (FIG. 7).

One embodiment of a software script is shown in FIG. 11. The script automates the entry of requested information as per the user's request in 1038. The process then flows to 1046 where the script may appropriately apply a specified combination of randomized timing, source and content of the data inputs into the password-protected databases in order to mimic human behavior. The process then flows to 1048 where the script may initiate a search within the database. The process then flows to 1050 where the search may yield results. The process then flows to 1052 where the results may be parsed. The process then flows to 1054 where the system logs out of the user's network. Block 1056 represents the aggregation of both simultaneous streams of data. Both private-search parsed data results and public parsed data results from 1052 are combined to return aggregated results.

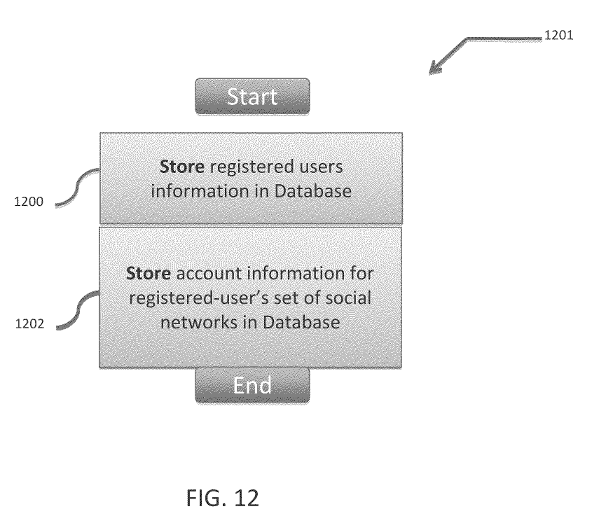

FIG. 12 illustrates a logical flow diagram generally showing one embodiment of a the design of a system which stores registered user information along with a set of the user's arbitrary networks and each network's user name and password login information. The FIG. 12 begins after 1201 with a start block after which 1200 represents the process whereby a database may be created which may store information on registered users. The process flows to block 1202 whereby a database maybe created which stores account information for the arbitrary social networks belonging to the registered users. The process then ends.

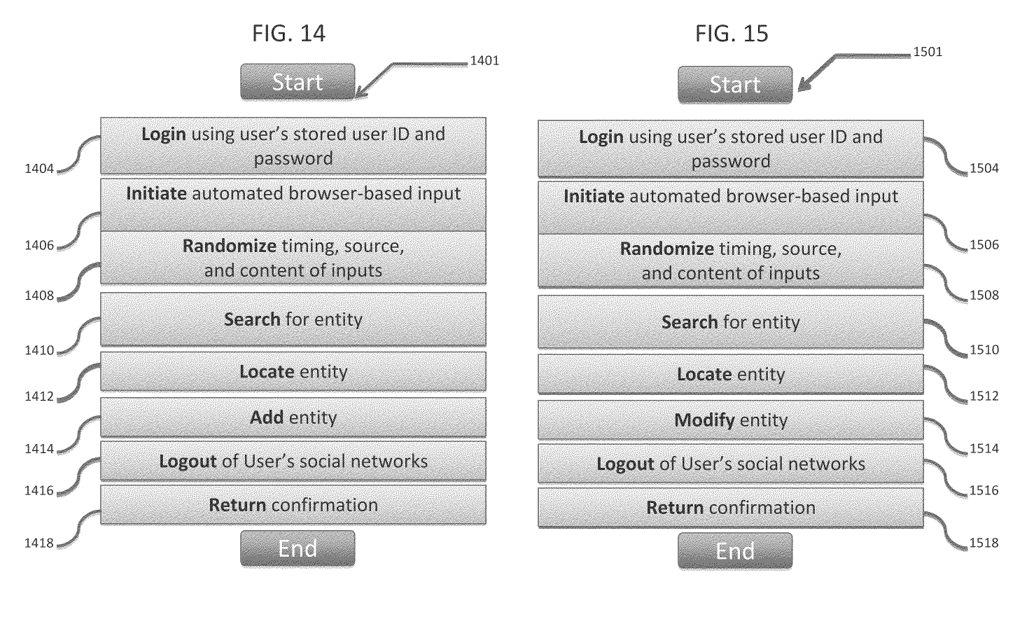

FIG. 14 illustrates a logical flow diagram generally showing one embodiment of a process for creating a relationship from the actionable results generated by the GLUE system. Process 1401 of FIG. 14 may be initiated from the client devices on FIG. 1, a web-based desktop computer, or any other input device shown on FIG. 1. Process 1401 of FIG. 14 may also be initiated in real-time after the search has been initiated in yielded results at the end of flows of FIG. 10A, FIG. 10B or FIG. 10C, or they may be initiated from stored data from FIG. 18. The process 1401 begins after a start block with 1404. Process 1401 may be initiated where a user may choose, as an example, to add a contact or create/add a product to an order. At step 1404, the system may then retrieve the user's stored network and login username/password information. The process then flows to 1406 where the system may initiate the launch of a browser window and automate the input of information and commands. The process then flows to 1408 where the system may randomize the timing, source and content of inputs to as to mimic human behavior and logon to the networks on behalf of its registered user. The process then flows to 1410 where the system initiates the search for the entity to be created/added. The process then flows to 1412 where the system locates the entity to be created/added. The process then flows to 1414 where the system then adds the entity. The process then flows to 1416 where the system then logs out of the registered user's databases. The process then flows to 1418 where the system returns a confirmation of the creation/addition.

FIG. 15 illustrates a logical flow diagram generally showing one embodiment of a process for modifying a relationship from the actionable results generated by the GLUE system. Process 1501 of FIG. 15 may be initiated from the client devices on FIG. 1, a web-based desktop computer, or any other input device shown on FIG. 1. Process 1501 of FIG. 15 may also be initiated in real time after the search has been initiated in yielded results at the end of flows of FIG. 10A, FIG. 10B, FIG. 10C or FIG. 10D, or they may be initiated from stored data from FIG. 18. The process 1501 begins after a start block with 1504. Process 1501 may be initiated where a user may choose, as an example, to modify a contact or modify a product to an order. At step 1504, the system may retrieve the user's stored network and login username/password information. The process then flows to 1506 where the system may initiate the launch of a browser window and automate the input of information and commands. The process then flows to 1508 where the system may randomize the timing, source and content of inputs to as to mimic human behavior and logon to the networks on behalf of its registered user. The process then flows to 1510 where the system initiates the search for the entity to be modified. The process then flows to 1512 where the system locates the entity to be modified. The process then flows to 1514 where the system then modifies the entity. The process then flows to 1516 where the system then logs out of the registered user's databases. The process then flows to 1518 where the system returns a confirmation of the modification.

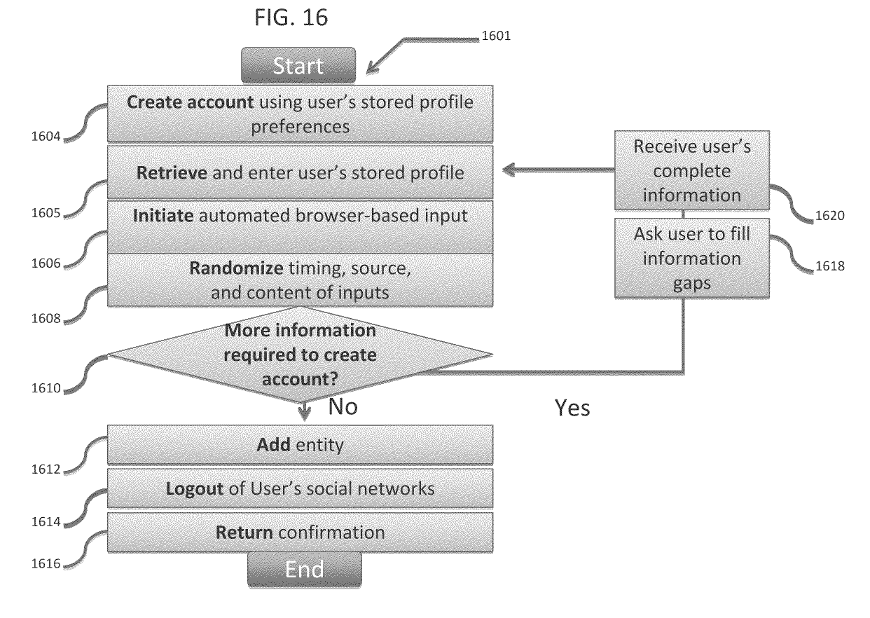

FIG. 16 illustrates a logical flow diagram generally showing one embodiment of a process for joining a network from the actionable results generated by the GLUE system. Process 1601 of FIG. 16 may be initiated from the client devices on FIG. 1, a web-based desktop computer, or any other input device shown on FIG. 1. Process 1601 of FIG. 16 may also be initiated in real time after the search has been initiated in yielded results at the end of flows of FIG. 10A, FIG. 10B or FIG. 10C, or they maybe initiated from stored data from FIG. 18. The process 1601 begins after a start block with 1600. Process 1601 may be initiated where the system may facilitate the joining of a network or new management database relationship with orders, data or other management information. At step 1604, the system may begin to create an account on behalf of its registered user. The process then flows to 1605 where the system then retrieves the user's stored network and login username/password information. The process then flows to 1606 where the system may initiate the launch of a browser window and automate the input of information and commands. The process then flows to 1608 where the system may randomize the timing, source and content of inputs to as to mimic human behavior and logon to the networks on behalf of its registered user. The process block 1610 is a decision block where a determination is made whether more information is needed in order for the system to automate the joining of a new network. If additional information is needed, the process then flows to 1618 initiating a request for the user to provide the necessary information; then the process flows to 1620 where the system receives the required information and returns to 1605 where it again retrieves the stored user profile. If all information is available, the process flows to 1612 where the system adds the entity to be created/added. The process then flows to 1614 where the system then logs out of the user's social network. The process then flows to 1616 where the system then returns a confirmation to the user. The process then flows to 1616 where the system returns a confirmation of the creation/addition.

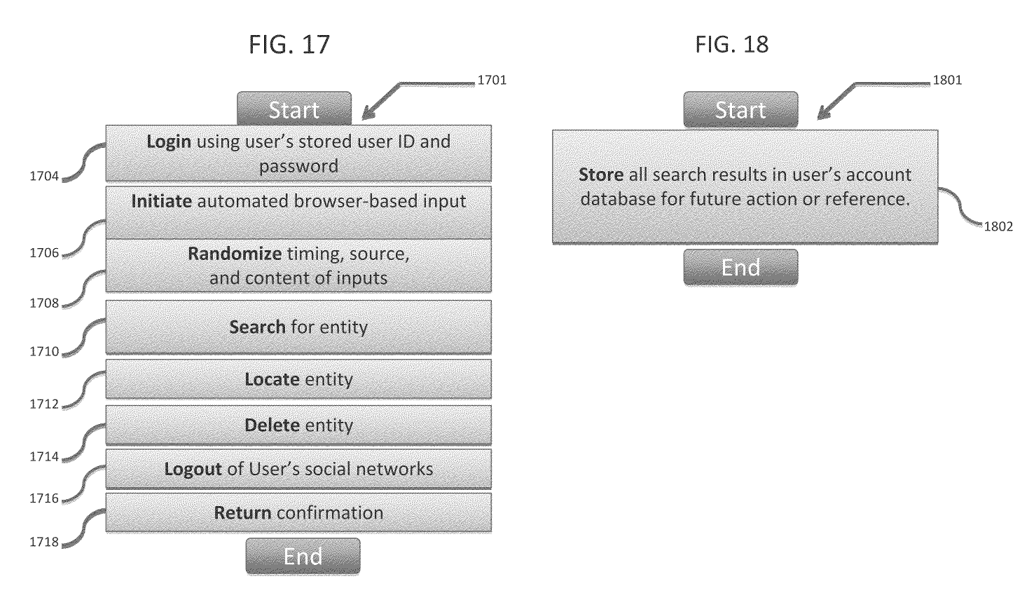

FIG. 17 illustrates a logical flow diagram generally showing one embodiment of a process for deleting a relationship from the actionable results generated by the GLUE system. Process 1701 of FIG. 17 may be initiated from the client devices on FIG. 1, a web-based desktop computer, or any other input device shown on FIG. 1. Process 1701 of FIG. 17 may also be initiated in real time after the search has been initiated in yielded results at the end of flows of FIG. 10A, FIG. 10B or FIG. 10C or they may be initiated from stored data from FIG. 18. The process 1701 begins after a start block with 1700. Process 1701 may be initiated where the system may delete a relationship between people in two networks or generate the addition or orders, data or other management information. At step 1704, the system may retrieve the user's stored network and login username/password information. The process then flows to 1706 where the system may initiate the launch of a browser window and automate the input of information and commands. The process then flows to 1708 where the system may randomize the timing, source and content of inputs to as to mimic human behavior and logon to the networks on behalf of its registered user. The process then flows to 1710 where the system initiates the search for the entity to be deleted. The process then flows to 1712 where the system locates the entity to be deleted. The process then flows to 1714 where the system then deletes the entity. The process then flows to 1716 where the system then logs out of the registered user's databases. The process then flows to 1718 where the system returns a confirmation of the deletion.

FIG. 18 illustrates a logical flow diagram generally showing one embodiment of a process for storing all results from the generated by the GLUE system. Process 1801 of FIG. 18 may be initiated from the client devices on FIG. 1, a web-based desktop computer, or any other input device shown on FIG. 1. Process 1801 of FIG. 18 may also be initiated in real time after the search has been initiated in yielded results at the end of flows of FIG. 10A, FIG. 10B or FIG. D, or they may be initiated from stored data from FIG. 18. The process 1801 may begin where the system may facilitate the storage of a relationship between people in two networks or generate the storage of data related to orders, sales or other management information. The process executes 1802 where all search results are stored in the registered user's account database for future action or reference. It is to be understood that at the completion of any of these processes, the system can return to processing other processes, including but not limited to those described herein. When searching a social network or its associated private database, a process may encounter a human interactive proof. The purpose of such a proof is to eliminate automated systems from accessing protected databases. Whenever such a human interactive proof (HIP) arises, such as a CAPTCHA test, the process may relay those aspects of the test (e.g., a graphical image) necessary for human interpretation. The user may then enter into a field the appropriate response, which the process may then relay to the appropriate system. For instance, if a user attempts to search for a contact on a social network using the processes described above, the process may be required to pass a HIP. Alternatively, it may also encounter a request for information that the process does not possess. As such, the requested information may be passed to the user by the process. For example, it may be a graphical image of distorted text. The user may then interpret the information presented and may enter a response to the inquiry. The process may then submit the response to the social network and may thereafter continue with its execution.

FIG. 6D shows a user interface for managing information for social networks in accordance with one embodiment of the teachings herein. For instance, the user of the system may wish to compare her participation in at least two or more social networks with a contact's membership in various social networks. For instance, the system described herein may provide the user with information describing all the social networks the user belongs to and all the social networks that the contact (e.g., John Smith) belongs to. In further aspects, the system described herein may provide the user with information describing all the social networks that the client's contacts belong to. The system described herein may also provide the user with a graph describing which social networks both the user and contact belong to, which network the user only belongs to, which network the contact belongs to, and which social networks neither the user or contact may be long to. For instance, FIG. 5D illustrates an example according to one aspect where the user and contact John Smith both belong to LINKEDIN and FACEBOOK, that between the two John Smith only belongs to ATTORNEYNET while the User belongs to Google Contacts and Twitter, and that between them again neither belongs to YOUNOODLE, PLAXO, NING, or Orkut.

FIG. 9A-9D shows a user interface or data scheme for managing information for social networks in accordance with one embodiment of the teachings herein. Mechanisms for constructing such user interface or data scheme are incorporated by reference (See http://en.wikipedia.org/wiki/Socialnetwork#References; http://en.wikipedia.org/wiki/Socialnetwork analysis software). FIG. 9A provides an example according to one aspect of the teachings herein, wherein the system described herein may provide a nodal display describing “betweeness”. FIG. 9B shows an example according to one aspect of the teachings herein, wherein the system described herein may collate and display a table showing various metrics describing the information collected about the various social networks. For instance, the system may provide on a per user basis metrics that provide a quantitative measure of the common activity between the user and other contacts on their common social networks. FIG. 9C shows an example according to one aspect of the teachings herein, wherein the system described herein may display a measure of the number of “friends” a user has in each social network that both the user and contact both belong to. The system described herein may further display a measure of the number of “friends” the contact has in each social network that both the user and contact both belong to. These results may be presented by the system described herein as a spider graph, FIG. 9C, or as a table, FIG. 9D.

FIG. 5 shows a data scheme for managing information for social networks in accordance with one embodiment of the teachings herein. For instance, the system described herein may tabulate for each social network the user belongs to: 1) what kind of network service does it provide, whether it is firewalled, what language to use, what username to use, what password to use, what email to use, or the types of contacts should be added to that social network.

FIG. 6 is a flow chart for a process for managing information for social networks in accordance with one embodiment of the teachings herein. For instance, the example provided in FIG. 6 shows how the user may respond to the results of the system described herein.

FIG. 20 shows a data scheme for managing information for social networks in accordance with one embodiment of the teachings herein. For instance, the system described herein may tabulate for each network application the user belongs to: 1) what kind of network service does it provide, whether it is firewalled, what language to use, what username to use, what password to use, what email to use, etc.

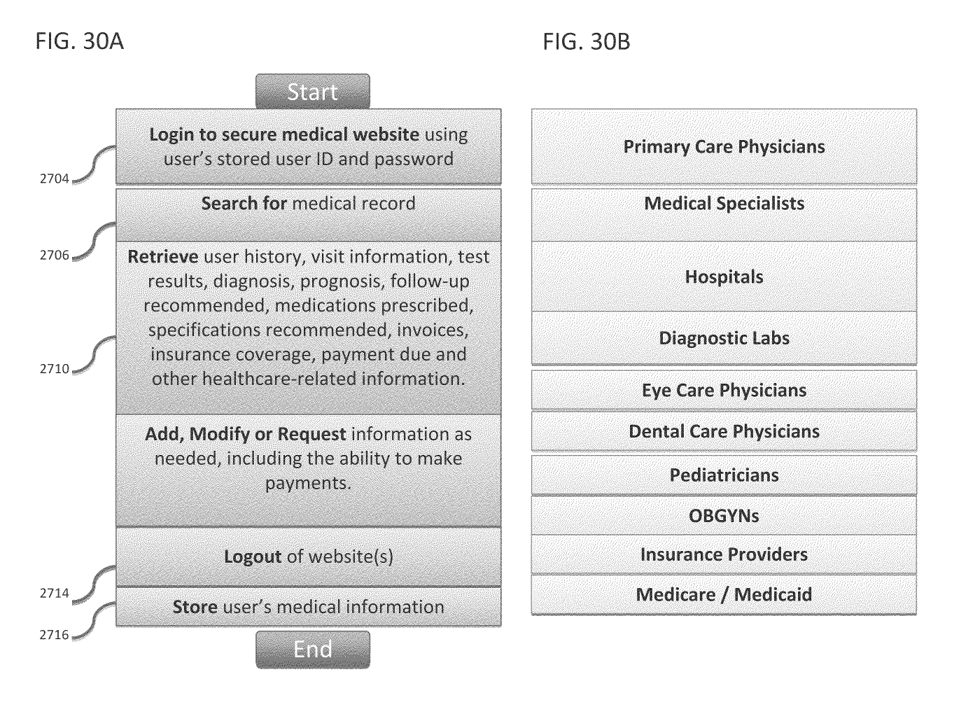

Provided herein is a tool that enables a record holder to store password information on multiple arbitrary databases, it can also provide that a patient, or designee, may record password information to gain access, or grant access, to multiple arbitrary databases to report on medical history. The system or method which further compromises facilitating the user's aggregate search, retrieval and management (FIGS. 30A and 30B) of medical history, specifically insofar as retrieving one's personal medical visit information, diagnosis, prognosis, medications prescribed, recommendations made, tests taken, test results, follow-up suggested, costs incurred, costs covered by insurance, cost to the patient, invoices sent and payments received.

For the sake of brevity, it should be understood that certain structures and functionality, or aspects thereof, of embodiments of the present invention that are evident from the illustrations of the Figures have not been necessarily restated herein. A computer or processor readable medium such as a floppy disk, CD-ROM, DVD, etc. may be use to store the processes, techniques, software, and information illustratively described herein. The media may store instructions, which when executed by a computer processor causes the processor to perform the processes described herein. The media can also be stored on devices, such as a server device, within a database, within main memory, within secondary storage, or the like. A server can comprise many networked computers. Each step of the various embodiments in the teachings can be practiced on one more of the computers in a server farm. The software can be stored in computer readable memory where such storage is non-transient memory.

It is to be understood that the invention is not to be limited to the exact configuration as illustrated and described herein. Accordingly, all expedient modifications readily attainable by one of ordinary skill in the art from the disclosure set forth herein, or by routine experimentation there from, are deemed to be within the spirit and scope of the invention as defined by the appended claims.

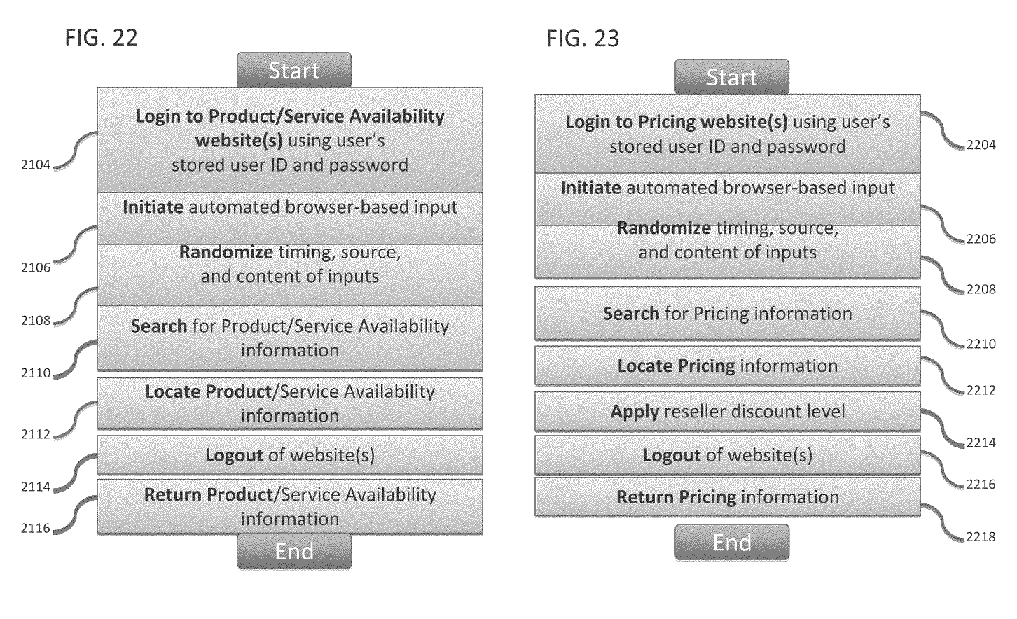

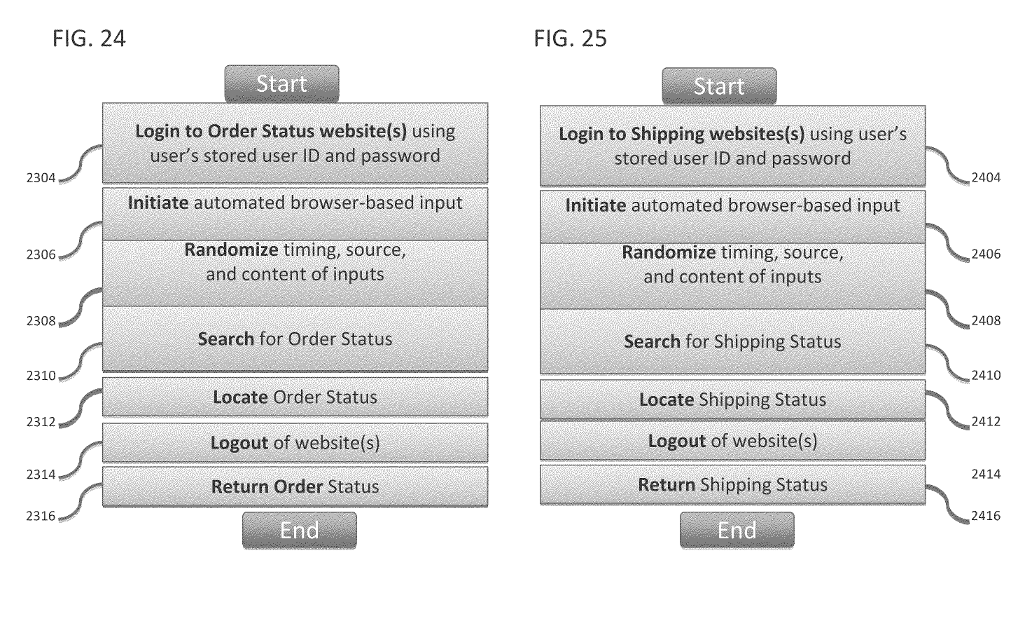

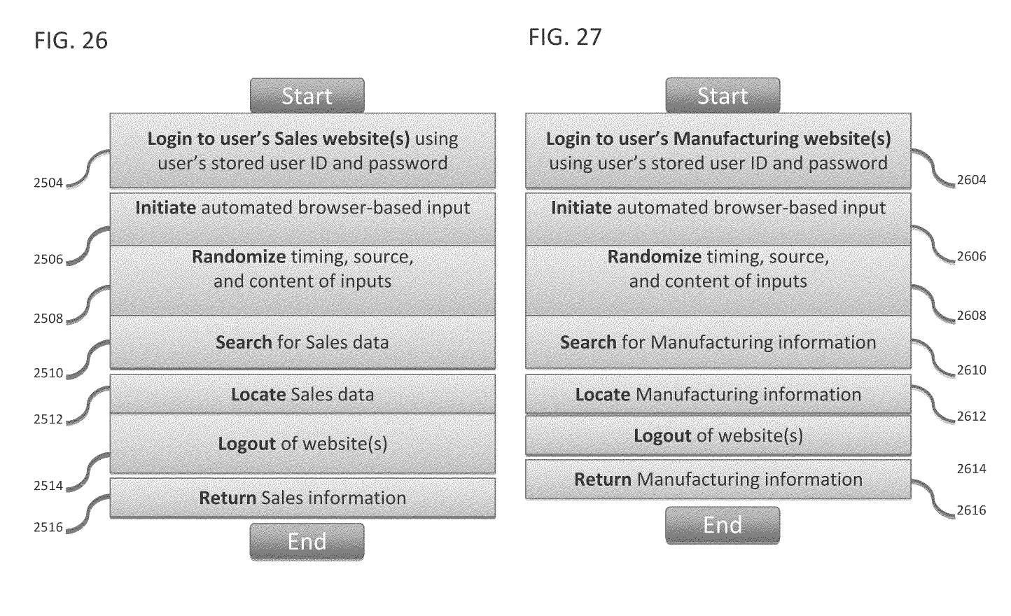

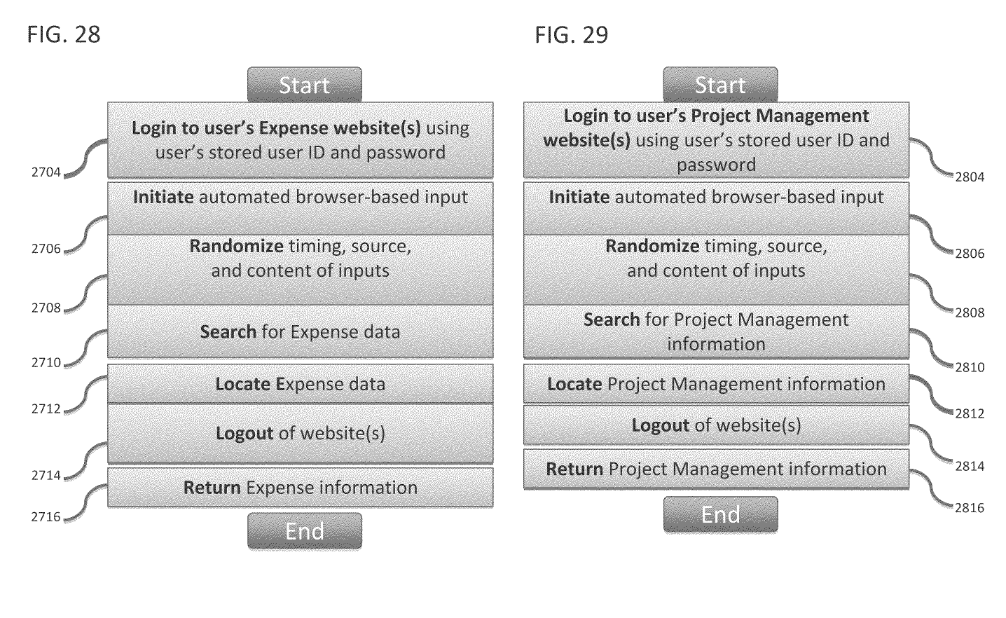

The invention described herein may have a variety of further uses. For instance, the teachings herein may be applicable toward medical records, purchasing, inventory, shipping, production, project management, revenue and expense information based on stored identification information, preferences and profile, including but not limited to checking and managing availability information (e.g., FIG. 22), receiving and managing pricing information (e.g., FIG. 23), checking and managing order information (e.g., FIG. 24), checking and managing shipping information (e.g., FIG. 25), checking and managing sales information (e.g., FIG. 26), checking and managing manufacturing status information (e.g., FIG. 27), checking and managing expenses information (e.g., FIG. 28), or checking and managing project management information (e.g., FIG. 29).

1. A system that automates the connection of its users with the users of an arbitrary set of social networks. Comprising:
storing its user's account information for an arbitrary set of third party networks:
receiving requests from users containing a manner of identifying information in a variety of forms using mobile or other inputs to search across an arbitrary set of social networks for individuals, organizations, or groups;
scanning and indexing the user's computing devices for clarifying information on the searched-for entity;
finding relationships between the searching user and the searched-for entity, if any, across an arbitrary set of social networks;
returning a list of such relationships and a list of new possible relationships across social networks; and
adding to aggregate social network analytics data; wherein said users are connected in real-time across an arbitrary set of social networks.

2. A method for searching an arbitrary set of social networks for a given individual, organization, or group comprising:
receiving from the searching user, some manner of identifying information for an individual, organization, or group;
scanning and indexing the user's computing devices for clarifying information on the searched-for entity;
executing privately available searches across arbitrary social networks by assuming the searching user's identity and/or simulating a human interaction with the browser-based interface to an arbitrary social network;
executing publicly available searches across arbitrary social networks
or, executing both publicly and privately available searches across arbitrary social networks;
creating human-like interactions by automating browser-based input and randomizing the timing, source, and content of those inputs;
parsing the results of these searches; and
presenting actionable decisions to the searching user based on search results.

3. A design for a system capable of automating the search for users of arbitrary social networks comprising:
a client application that stores registered users in a database; and
a database that stores the account information for the set of social networks to which each registered user belongs.

4. The system of claim 1 which further compromises facilitating the user's management of those relationships given their identification information and their user profile.

5. The system of claim 4 comprising addition into existing networks

6. The system of claim 4 comprising modification of relationship within a network

7. The system of claim 4 comprising joining of new network

8. The system of claim 4 comprising deletion of participation in network

9. The system of claim 4 comprising storing of network information

10. The system of claim 1 which further compromises facilitating the user's aggregate search, retrieval and management of purchasing, inventory, shipping, production, project management, revenue and expense information based on stored identification information, preferences and profile.

11. The system of claim 10 comprising checking and managing availability information.

12. The system of claim 10 comprising receiving and managing pricing information.

13. The system of claim 10 comprising checking and managing order information.

14. The system of claim 10 comprising checking and managing shipping information.

15. The system of claim 10 comprising checking and managing sales information.

16. The system of claim 10 comprising checking and managing manufacturing status information.

17. The system of claim 10 comprising checking and managing expenses information.

18. The system of claim 10 comprising checking and managing project management information.

19. The system of claim 10 comprising storing of search results.
